(19) United States
(12) Patent Application Publication
(10) Pub. No.: US 2026/0127607 A1
(43) Pub. Date: May 7, 2026

(54) COMPUTER SYSTEMS AND METHODS FOR MITIGATING FRAUDULENT TRANSACTION ACTIVITY

(71) Applicant: Capital One Financial Corporation, McLean, VA (US)

(72) Inventors: Razvan Oltean, Katy, TX (US); Pranjal Desai, Cypress, TX (US)

(21) Appl. No.: 18/936,542

(22) Filed: Nov. 4, 2024

(51) Int. Cl. G06Q 20/40

(52) U.S. Cl. CPC G06Q 20/4016

(57) ABSTRACT

A computing platform is configured to (i) identify a candidate set of card-not-present (CNP) transactions that are candidates for potential involvement in fraudulent activity, (ii) for each respective CNP transaction in the candidate set, determine a respective combination of transaction-element values for a set of transaction elements comprising at least (a) a first transaction element indicating a Bank Identification Number (BIN) number of a respective PAN involved in the respective CNP transaction, (b) a second transaction element indicating a client involved in the respective CNP transaction, and (c) a third transaction element indicating a merchant involved in the respective CNP transaction, (iii) based on an evaluation of the respective combinations of transaction-element values determined for the CNP transactions in the candidate set, identify at least one at-risk combination of transaction-element values that is associated with a risk of fraudulent activity, and (iv) use the identified at least one at-risk combination of transaction-element values as a basis for deploying logic for identifying CNP transactions that present a risk of fraudulent activity.

### BACKGROUND

Card-not-present (CNP) transactions are becoming increasingly common. CNP transactions offer convenience to both cardholders and merchants, allowing for cardholders to initiate transactions remotely from merchant points of service and thereby removing the need for many of the physical tools that may be required for card-present (CP) transactions at merchant points of service. Processing CNP transactions typically involves a two-stage process, including an “authorization” stage and a “settlement” stage.

During one possible implementation of the authorization stage, a merchant's computing platform may send an authorization request for a CNP transaction initiated by a consumer to a computing platform of the merchant's acquiring financial institution (often referred to as the “acquirer bank”) or an associated processor, which in turn routs the authorization request to a computing platform of the financial institution that issued the payment card used for the CNP transaction (often referred to as the “issuing bank”) over a payment network. After receiving the authorization request, the issuing bank's computing platform renders a decision as to whether the CNP transaction should be approved or denied and generates an authorization response memorializing that decision, which gets routed back to the acquirer bank's computing platform (or an associated processor) and then back to the merchant's computing platform.

Then, during one possible implementation of the settlement stage, the merchant's computing platform sends a settlement request for the authorized CNP transaction (and perhaps other authorized CNP transactions) to the acquirer bank's computing platform or an associated processor, which in turn routes the settlement request to the issuing bank's computing platform over a payment network. After the issuing bank receives and approves the settlement request, the funds for the CNP transaction are transferred from the issuing bank's computing platform to the acquirer bank's computing platform through the payment network, the acquirer bank deposits the proceeds from the CNP transaction into a bank account of the merchant, and the issuer bank charges the cardholder for the CNP transaction.

The processing of a CNP transaction could take various other forms as well.

### OVERVIEW

Disclosed herein is new technology for mitigating fraudulent CNP transaction activity.

In a first aspect, the disclosed technology may involve computer-implemented functionality for (a) identifying a candidate set of card-not-present (CNP) transactions that are candidates for potential involvement in fraudulent activity, (b) for each respective CNP transaction in the candidate set, determining a respective combination of transaction-element values for a set of transaction elements comprising at least (i) a first transaction element indicating a Bank Identification Number (BIN) number of a respective PAN involved in the respective CNP transaction, (ii) a second transaction element indicating a client involved in the respective CNP transaction, and (iii) a third transaction element indicating a merchant involved in the respective CNP transaction, (c) based on an evaluation of the respective combinations of transaction-element values determined for the CNP transactions in the candidate set, identifying at least one at-risk combination of transaction-element values that is associated with a risk of fraudulent activity (e.g., a combination that includes a respective transaction-element value for each transaction element in the set of transaction elements), and (d) using the identified at least one at-risk combination of transaction-element values as a basis for deploying logic for identifying CNP transactions that present a risk of fraudulent activity (e.g., by defining the logic for identifying CNP transactions that present the risk of fraudulent activity based on the identified at least one at-risk combination of transaction-element values and then either utilizing the logic to evaluate new CNP transactions at the computing platform or causing one or more other computing platforms to begin utilizing the logic to evaluate new CNP transactions).

In this first aspect, the function of identifying the candidate set of CNP transactions may take any of various forms. For instance, as one possibility, the function of identifying the candidate set of CNP transactions may involve identifying an initial set of CNP transactions that were processed during a past window of time (e.g., a set of CNP transactions involving a given issuer bank that were processed during the past window of time), identifying a set of primary account numbers (PANs) involved in CNP transactions from the initial set (e.g., a set of PANs involved in less than a threshold number of CNP transactions from the initial set), and then for each respective PAN in the identified set of PANs, (i) determining a respective numeric difference between the respective PAN and a next-closest PAN in the identified set of PANs, (ii) comparing the respective numeric difference determined for the respective PAN to a threshold numeric difference, and (iii) if the respective numeric difference determined for the respective PAN does not exceed the threshold numeric difference, identifying each CNP transaction from the initial set that involved the respective PAN as a CNP transaction to include in the candidate set. The functionality for identifying the candidate set of CNP transactions may take other forms as well.

Further, in this first aspect, the set of transaction elements may include one or more additional transaction elements, examples of which may include a first additional transaction element indicating an issuer bank for the respective PAN involved in the respective CNP transaction, a second additional transaction element indicating a transaction amount of the respective CNP transaction, and/or a third additional transaction element indicating a processing result of the respective CNP transaction.

Further yet, in this first aspect, the function of identifying the at least one at-risk combination of transaction-element values based on the evaluation of the respective combinations of transaction-element values determined for the CNP transactions in the candidate set may take any of various forms. For instance, as one possibility, the function of identifying the at least one at-risk combination of transaction-element values based on the evaluation of the respective combinations of transaction-element values determined for the CNP transactions in the candidate set may involve defining groups of CNP transactions that each correspond to a distinct combination of transaction-element values for the set of transaction elements, and then for each respective group of the defined groups of CNP transactions, (i) determining a respective number of CNP transactions included in the respective group, (ii) comparing the respective number of CNP transactions included in respective group to a threshold number of CNP transactions, and (iii) if the respective number of CNP transactions included in respective group exceeds the threshold number of CNP transactions, identifying the respective group's distinct combination of transaction-element values as an at-risk combination of transaction-element values.

Still further, in this first aspect, the logic for identifying CNP transactions that present the risk of fraudulent activity may take any of various forms. For instance, as one possibility, the logic for identifying CNP transactions that present the risk of fraudulent activity may comprise a conditional statement that corresponds to the identified at least one at-risk combination of transaction-element values and includes at least a first condition that checks for a given BIN number value, a second condition that checks for a given client value, a third condition that checks for a given merchant value, among other possible forms of the logic.

In at least some implementations, the logic for identifying CNP transactions that present the risk of fraudulent activity may also have a defined expiration time, and in such implementations, the computer-implemented functionality may further involve extending the defined expiration time of the logic for identifying CNP transactions that present the risk of fraudulent activity if, prior to the defined expiration time, the logic results in an identification of at least one new CNP transaction that present the risk of fraudulent activity.

In a second aspect, the disclosed technology may involve computer-implemented functionality for (a) identifying a candidate set CNP transactions that are candidates for potential involvement in fraudulent activity by identifying an initial set of CNP transactions that were processed during a past window of time (e.g., a set of CNP transactions involving a given issuer bank that were processed during the past window of time), identifying a set of PANs involved in CNP transactions from the initial set (e.g., a set of PANs involved in less than a threshold number of CNP transactions from the initial set), and then for each respective PAN in the identified set of PANs, (i) determining a respective numeric difference between the respective PAN and a next-closest PAN in the identified set of PANs, (ii) comparing the respective numeric difference determined for the respective PAN to a threshold numeric difference (e.g., a numeric value that is selected from a numeric range between 20 and 50), and (iii) if the respective numeric difference determined for the respective PAN does not exceed the threshold numeric difference, identifying each CNP transaction from the initial set that involved the respective PAN as a CNP transaction to include in the candidate set, (b) for each respective CNP transaction in the candidate set, determining a respective combination of transaction-element values for a set of transaction elements comprising (i) a first transaction element indicating a BIN number of a respective PAN involved in the respective CNP transaction, (ii) a second transaction element indicating a respective client involved in the respective CNP transaction, and (iii) a third transaction element indicating a respective merchant involved in the respective CNP transaction, (c) based on an evaluation of the respective combinations of transaction-element values determined for the CNP transactions in the candidate set, identify at least one at-risk combination of transaction-element values that is associated with a risk of fraudulent activity (e.g., a combination that includes a respective transaction-element value for each transaction element in the set of transaction elements), and (d) using the identified at least one at-risk combination of transaction-element values as a basis for deploying logic for identifying CNP transactions that present a risk of fraudulent activity (e.g., by defining the logic for identifying CNP transactions that present the risk of fraudulent activity based on the identified at least one at-risk combination of transaction-element values and then either utilizing the logic to evaluate new CNP transactions at the computing platform or causing one or more other computing platforms to begin utilizing the logic to evaluate new CNP transactions).

In this second aspect, the set of transaction elements may include one or more additional transaction elements, such as a fourth transaction element indicating an issuer bank for the respective PAN involved in the respective CNP transaction.

Further, in this second aspect, the function of identifying the at least one at-risk combination of transaction-element values based on the evaluation of the respective combinations of transaction-element values determined for the CNP transactions in the candidate set may take any of various forms. For instance, as one possibility, the function of identifying the at least one at-risk combination of transaction-element values based on the evaluation of the respective combinations of transaction-element values determined for the CNP transactions in the candidate set may involve defining groups of CNP transactions that each correspond to a distinct combination of transaction-element values for the set of transaction elements, and then for each respective group of the defined groups of CNP transactions, (i) determining a respective number of CNP transactions included in the respective group, (ii) comparing the respective number of CNP transactions included in respective group to a threshold number of CNP transactions, and (iii) if the respective number of CNP transactions included in respective group exceeds the threshold number of CNP transactions, identifying the respective group's distinct combination of transaction-element values as an at-risk combination of transaction-element values.

Further yet, in this second aspect, the logic for identifying CNP transactions that present the risk of fraudulent activity may take any of various forms. For instance, as one possibility, the logic for identifying CNP transactions that present the risk of fraudulent activity may comprise a conditional statement that corresponds to the identified at least one at-risk combination of transaction-element values, which may take any of various forms. For example, the conditional statement may include a respective condition that is based on each of the transaction-element values in the identified at least one at-risk combination of transaction-element values, and in one possible implementation where the identified at least one at-risk combination of transaction-element values includes a BIN11 number value, the conditional statement may comprise a condition that checks for a BIN10 number value corresponding to the BIN11 number value, among other possible examples.

In at least some implementations, the logic for identifying CNP transactions that present the risk of fraudulent activity may also have a defined expiration time, and in such implementations, the computer-implemented functionality may further involve extending the defined expiration time of the logic for identifying CNP transactions that present the risk of fraudulent activity if, prior to the defined expiration time, the logic results in an identification of at least one new CNP transaction that present the risk of fraudulent activity.

In a third aspect, the disclosed technology may involve computer-implemented functionality for (a) identifying a candidate set CNP transactions that are candidates for potential involvement in fraudulent activity by identifying an initial set of CNP transactions that were processed during a past window of time (e.g., a set of CNP transactions involving a given issuer bank that were processed during the past window of time), identifying a set of PANs involved in CNP transactions from the initial set (e.g., a set of PANs involved in less than a threshold number of CNP transactions from the initial set), and then for each respective PAN in the identified set of PANs, (i) determining a respective numeric difference between the respective PAN and a next-closest PAN in the identified set of PANs, (ii) comparing the respective numeric difference determined for the respective PAN to a threshold numeric difference (e.g., a numeric value that is selected from a numeric range between 50 and 1000), and (iii) if the respective numeric difference determined for the respective PAN does not exceed the threshold numeric difference, identifying each CNP transaction from the initial set that involved the respective PAN as a CNP transaction to include in the candidate set for each respective CNP transaction in the candidate set, (b) for each respective CNP transaction in the candidate set, determining a respective combination of transaction-element values for a set of transaction elements comprising (i) a first transaction element indicating a BIN number of a respective PAN involved in the respective CNP transaction, (ii) a second transaction element indicating a client involved in the respective CNP transaction, (iii) a third transaction element indicating a merchant involved in the respective CNP transaction, and (iv) a fourth transaction element indicating a transaction amount of the respective CNP transaction, (c) based on an evaluation of the respective combinations of transaction-element values determined for the CNP transactions in the candidate set, identifying at least one at-risk combination of transaction-element values that is associated with a risk of fraudulent activity (e.g., a combination that includes a respective transaction-element value for each transaction element in the set of transaction elements), and (d) using the identified at least one at-risk combination of transaction-element values as a basis for deploying logic for identifying CNP transactions that present a risk of fraudulent activity (e.g., by defining the logic for identifying CNP transactions that present the risk of fraudulent activity based on the identified at least one at-risk combination of transaction-element values and then either utilizing the logic to evaluate new CNP transactions at the computing platform or causing one or more other computing platforms to begin utilizing the logic to evaluate new CNP transactions).

In this third aspect, the set of transaction elements may include one or more additional transaction elements, such as a fourth transaction element indicating an issuer bank for the respective PAN involved in the respective CNP transaction.

Further, in this third aspect, the function of identifying the at least one at-risk combination of transaction-element values based on the evaluation of the respective combinations of transaction-element values determined for the CNP transactions in the candidate set may take any of various forms. For instance, as one possibility, the function of identifying the at least one at-risk combination of transaction-element values based on the evaluation of the respective combinations of transaction-element values determined for the CNP transactions in the candidate set may involve defining groups of CNP transactions that each correspond to a distinct combination of transaction-element values for the set of transaction elements, and then for each respective group of the defined groups of CNP transactions, (i) determining a respective number of CNP transactions included in the respective group, (ii) comparing the respective number of CNP transactions included in respective group to a threshold number of CNP transactions, and (iii) if the respective number of CNP transactions included in respective group exceeds the threshold number of CNP transactions, identifying the respective group's distinct combination of transaction-element values as an at-risk combination of transaction-element values.

Further yet, in this third aspect, the logic for identifying CNP transactions that present the risk of fraudulent activity may take any of various forms. For instance, as one possibility, the logic for identifying CNP transactions that present the risk of fraudulent activity may comprise a conditional statement that corresponds to the identified at least one at-risk combination of transaction-element values, which may take any of various forms. For example, the conditional statement that corresponds to the identified at least one at-risk combination of transaction-element values may comprise a conditional statement that includes conditions for evaluating transaction-element values of the first, second, and third data elements but does not include a condition for evaluating transaction-element values of the fourth data element, among other possible examples.

In at least some implementations, the logic for identifying CNP transactions that present the risk of fraudulent activity may also have a defined expiration time, and in such implementations, the computer-implemented functionality may further involve extending the defined expiration time of the logic for identifying CNP transactions that present the risk of fraudulent activity if, prior to the defined expiration time, the logic results in an identification of at least one new CNP transaction that present the risk of fraudulent activity.

In a fourth aspect, the disclosed technology may involve computer-implemented functionality for (a) identifying a candidate set of CNP transactions that are candidates for potential involvement in fraudulent activity (b) for each respective CNP transaction in the candidate set, determining a respective combination of transaction-element values for a set of transaction elements comprising (i) a first transaction element indicating a BIN number of a respective PAN involved in the respective CNP transaction, (ii) a second transaction element indicating a client involved in the respective CNP transaction, (iii) a third transaction element indicating a merchant involved in the respective CNP transaction, and (iv) a fourth transaction element indicating a processing result of the respective CNP transaction, (c) based on an evaluation of the respective combinations of transaction-element values determined for the CNP transactions in the candidate set, defining groups of CNP transactions that each correspond to (i) a distinct combination of transaction-element values for the first, second, and third transaction elements and (ii) a count of CNP transactions having a processing result of declined by financial institution that are within the respective group, (d) based on an evaluation of the defined groups of CNP transactions, identifying at least one at-risk combination of transaction-element values that is associated with a risk of fraudulent activity (e.g., a combination that includes transaction-element values for the first, second, and third transaction elements), and (e) using the identified at least one at-risk combination of transaction-element values as a basis for deploying logic for identifying CNP transactions that present a risk of fraudulent activity (e.g., by defining the logic for identifying CNP transactions that present the risk of fraudulent activity based on the identified at least one at-risk combination of transaction-element values and then either utilizing the logic to evaluate new CNP transactions at the computing platform or causing one or more other computing platforms to begin utilizing the logic to evaluate new CNP transactions).

In this fourth aspect, the function of identifying the candidate set of CNP transactions may take any of various forms. For instance, as one possibility, the function of identifying the candidate set of CNP transactions may involve identifying an initial set of CNP transactions that were processed during a past window of time (e.g., a set of CNP transactions involving a given issuer bank that were processed during the past window of time), identifying a set of PANs involved in less than a threshold number of CNP transactions from the initial set, and then for each respective PAN in the identified set of PANs, identifying each CNP transaction from the initial set that involved the respective PAN as a CNP transaction to include in the candidate set.

Further, in this fourth aspect, the set of transaction elements may include one or more additional transaction elements, such as a fourth transaction element indicating an issuer bank for the respective PAN involved in the respective CNP transaction.

Further yet, in this fourth aspect, the function of defining the groups of CNP transactions may take any of various forms, and as one possibility, may involve defining groups of CNP transactions that include one or both of (i) a threshold number of CNP transactions having the processing result of declined by financial institution or (ii) the threshold number of CNP transactions having the processing result of approved.

Still further, in this fourth aspect, the function of identifying the at least one at-risk combination of transaction-element values based on the evaluation of the defined groups of CNP transactions may take any of various forms. For instance, as one possible implementation, the function of identifying the at least one at-risk combination of transaction-element values based on the evaluation of the defined groups of CNP transactions may involve, for each respective group in the defined groups of CNP transactions, identifying the respective group's distinct combination of transaction-element values for the first, second, and third transactions elements as an at least one at-risk combination of transaction-element values if the respective group's count of CNP transactions having the processing result of declined by financial institution exceeds a threshold count of CNP transactions having the processing result of declined by financial institution. As another possible implementation in which each of the defined groups of CNP transactions further corresponds to a count of CNP transactions having a processing result of approved that are within the respective group, the function of identifying the at least one at-risk combination of transaction-element values based on the evaluation of the defined groups of CNP transactions may involve, for each respective group in the defined groups of CNP transactions, identify the respective group's distinct combination of transaction-element values for the first, second, and third transactions elements as an at least one at-risk combination of transaction-element values if (i) the respective group's count of CNP transactions having the processing result of declined by financial institution exceeds a threshold count of CNP transactions having the processing result of declined by financial institution and (ii) a ratio value indicating how the respective group's count of CNP transactions having the processing result of declined by financial institution compares to the respective group's count of CNP transactions having the processing result of approved exceeds a threshold ratio value. The function of identifying the at least one at-risk combination of transaction-element values based on the evaluation of the defined groups of CNP transactions may take other forms as well.

Still further yet, in this fourth aspect, the logic for identifying CNP transactions that present the risk of fraudulent activity may take any of various forms. For instance, as one possibility, the logic for identifying CNP transactions that present the risk of fraudulent activity may comprise a conditional statement that corresponds to the identified at least one at-risk combination of transaction-element values, which may take any of various forms. For example, the conditional statement that corresponds to the identified at least one at-risk combination of transaction-element values may comprise a conditional statement that includes conditions for evaluating transaction-element values of the first, second, and third data elements but does not include a condition for evaluating transaction-element values of the fourth data element, among other possible examples.

In at least some implementations, the logic for identifying CNP transactions that present the risk of fraudulent activity may also have a defined expiration time, and in such implementations, the computer-implemented functionality may further involve extending the defined expiration time of the logic for identifying CNP transactions that present the risk of fraudulent activity if, prior to the defined expiration time, the logic results in an identification of at least one new CNP transaction that present the risk of fraudulent activity.

The disclosed computer-implemented functionality may take various other forms as well.

Further, in practice, the disclosed computer-implemented functionality may be embodied in the form of a method to be carried out by a computing platform, a computing platform that is programmed to carry out the disclosed computing-implemented functionality, and/or a non-transitory computer-readable medium that is provisioned with program instructions for carrying out the disclosed computing-implemented functionality, among other possibilities.

One of ordinary skill in the art will appreciate these as well as numerous other aspects in reading the following disclosure.

### BRIEF DESCRIPTION OF THE DRAWINGS

FIG. 1 is a flowchart that shows an example process for authorizing an example CNP transaction between a cardholder and a merchant.

FIG. 2 is an example flow chart illustrating example functionality for mitigating fraudulent CNP transaction activity in accordance with a first aspect of the present disclosure.

FIG. 3A shows a simplified example to illustrate functionality carried out by a given computing platform in order to determine whether PANs from an initial set satisfy a first example criterion, in accordance with the present disclosure.

FIG. 3B shows a simplified example to illustrate functionality carried out by a given computing platform in order to determine whether PANs from an initial set satisfy a second example criterion, in accordance with the present disclosure.

FIG. 3C shows a simplified example to illustrate functionality carried out by a given computing platform in order to group a set of candidate CNP transactions based on an example combination of transaction data elements, in accordance with the present disclosure.

FIG. 3D shows a simplified example to illustrate functionality that may be carried out by a given computing platform in order to determine candidate transaction counts for distinct combinations of values for the example combination of transaction data elements, in accordance with the present disclosure.

FIG. 4 is an example flow chart illustrating example functionality for mitigating fraudulent CNP transaction activity in accordance with a second aspect of the present disclosure.

FIG. 5A shows a simplified example to illustrate functionality carried out by a given computing platform in order to determine whether PANs from an initial set satisfy a first example criterion, in accordance with the present disclosure.

FIG. 5B shows a simplified example to illustrate functionality carried out by a given computing platform in order to determine whether PANs from an initial set satisfy a second example criterion, in accordance with the present disclosure.

FIG. 5C shows a simplified example to illustrate functionality carried out by a given computing platform in order to group a set of candidate CNP transactions based on an example combination of transaction data elements, in accordance with the present disclosure.

FIG. 5D shows a simplified example to illustrate functionality that may be carried out by a given computing platform in order to determine candidate transaction counts for distinct combinations of values for the example combination of transaction data elements, in accordance with the present disclosure.

FIG. 6 is an example flow chart illustrating example functionality for mitigating fraudulent CNP transaction activity in accordance with a third aspect of the present disclosure.

FIG. 7A shows a simplified example to illustrate functionality carried out by a given computing platform in order to identify a set of candidate PANs that were involved in recent CNP transactions, in accordance with the present disclosure.

FIG. 7B shows a simplified example to illustrate functionality carried out by a given computing platform in order to group a set of candidate CNP transactions based on an example combination of transaction data elements, in accordance with the present disclosure.

FIG. 7C shows a simplified example to illustrate functionality that may be carried out by a given computing platform in order to determine candidate transaction counts for distinct combinations of values for the example combination of transaction data elements, in accordance with the present disclosure.

FIG. 7D shows a simplified example to illustrate functionality that may be carried out by a given computing platform in order to filter a set of groups of candidate CNP transactions, in accordance with the present disclosure.

FIG. 7E shows a simplified example to illustrate functionality that may be carried out by a given computing platform in order to produce updated combinations of transaction element values that are each associated with a respective count of candidate CNP transactions having a particular processing status, in accordance with the present disclosure.

FIG. 8 is a simplified block diagram that illustrates some structural components of an example computing platform that may be configured to carry out any of the various functions disclosed herein.

FIG. 9 is a simplified block diagram that illustrates some structural components of an example client device that may be configured to carry out any of the various functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

As noted above, card-not-present (CNP) transactions are becoming increasingly common. CNP transactions offer convenience to both cardholders and merchants, allowing for cardholders to initiate transactions remotely from merchant points of service and thereby removing the need for many of the physical tools that may be required for card-present (CP) transactions at merchant points of service. Processing CNP transactions typically involves two stages - an “authorization” process and a “settlement” process.

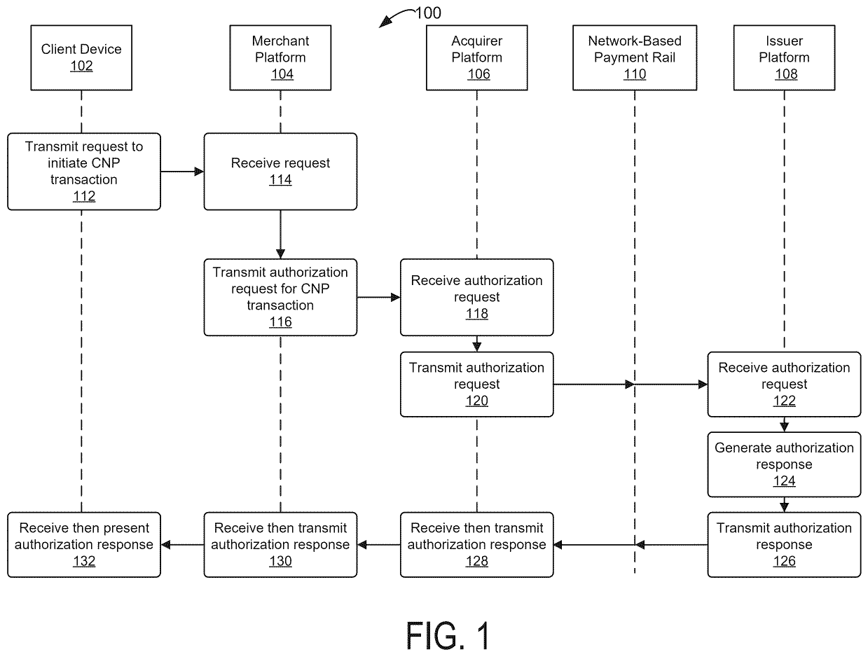

FIG. 1 is a flowchart 100 that shows an example process for authorizing an example CNP transaction within an example computing environment comprising a client device 102 operated by an individual in possession of payment card information for a given payment card (which could be the cardholder or someone else), a computing platform 104 operated by a merchant (referred to as a “merchant platform”), a computing platform 106 operated by an acquirer bank for the merchant (referred to as an “acquirer platform”), and a computing platform 108 operated by an issuer bank (referred to as an “issuer platform”).

In this example computing environment, the client device 102 may take any of various forms, and may include hardware components such as one or more processors, computer-readable mediums, communication interfaces, and input/output (I/O) components (or interfaces for connecting thereto), among other possible hardware components, as well as software that facilitates the client device's ability to interact with the merchant platform 104 to initiate CNP transactions. As representative examples, the client device 102 may take the form of a desktop computer, a laptop, a netbook, a tablet, a smartphone, or a personal digital assistant (PDA), among other possibilities.

Further, each of the computing platforms (i.e., the merchant platform 104, the acquirer platform 106, and the issuer platform 108) may take the form of one or more computing systems that collectively comprise some set of physical computing resources (e.g., processors, data storage, etc.) installed with software for processing CNP transactions (among other possible software). This set of physical computing resources may take any of various forms. As one possibility, such a computing platform may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, such a computing platform may comprise “on-premises” computing resources of the organization that operates the merchant platform 104 (e.g., organization-owned servers). As yet another possibility, such a computing platform may comprise a combination of cloud computing resources and on-premises computing resources. Other implementations of a computing platform are possible as well.

Further yet, network-based payment communications between the acquirer platform 106 and the issuer platform 108 may occur over a network-based payment rail 110, which may comprise any type of network-based payment rail that is configured to electronically transfer funds between financial institutions, examples of which may include a U.S. payment network operated by Discover®, American Express®, Mastercard®, or Visa®, an international payment network operated by the Society for Worldwide Interbank Financial Telecommunications (SWIFT) or Ripple, a real-time payment network (e.g., The Clearing House RTP® network), an Automated Clearing House (ACH) network, or a wire transfer network (e.g., Fedwire or the Clearing House Interbank Payments System (CHIPS)), among other possible examples of network-based payment networks.

In practice, the communication between entities within the example computing environment may be carried out over network-based communication paths, each of which may generally comprise one or more data networks and/or data links of various forms. For instance, each of the network-based communication paths discussed below may include any one or more of a Personal Area Networks, a Local-Area Networks (LAN), a Wide-Area Networks (WAN) such as the Internet or a cellular network, cloud network, and/or a point-to-point data link, among other possibilities, where each such data network and/or data link may be wireless, wired, or some combination thereof, and may carry data according to any of various different communication protocols. Although not shown, each of the network-based communication paths discussed below may also include one or more intermediate systems, examples of which may include a data aggregation system and host server, among other possibilities. Many other configurations are also possible.

Referring again to FIG. 1, the example authorization process may begin at block 112 with the client device 102 transmitting a request to initiate a CNP transaction over a network-based communication path to the merchant platform 104. The request to initiate the CNP transaction that is transmitted by the client device 102 to the merchant platform 104 may include any of various information that facilitates processing of the CNP transaction. As one example, the request may include information about the good or service that is to be purchased. As another example, the request may include payment card information associated with the payment card used to initiate the CNP transaction, such as the primary account number (PAN) or a tokenized version thereof, the expiration date, CVV/CVC code, and/or billing address associated with the payment card, among other possibilities. A portion of the PAN may represent the bank identification number (BIN) associated with the payment card, and in some implementations, the BIN may be a variable portion of the PAN (e.g., a 6-digit BIN6 number, an 8-digit BIN8 number, a 10-digit BIN10 number, an 11-digit BIN11 number, etc.). As yet another example, if the individual initiating the CNP transaction has previously set up an account with the merchant, the request may include account information for that individual (e.g., username, password, etc.), which may be sent either together with or in place of the payment card information. The request may include other information as well.

At block 114, the merchant platform 104 may receive the request transmitted by the client device 102. In turn, at block 116, the merchant platform 104 may transmit an authorization request for the CNP transaction to an acquirer platform 106 over a network-based communication path. It should be understood that, while illustrated as a direct communication between the merchant platform 104 and the acquirer platform 106, the flow of information between the merchant platform 104 and the acquirer platform 106 is not necessarily a direct communication and may take various forms. For example, the authorization request for the CNP transaction may be routed through various intermediaries (e.g., payment processors, secured transaction systems, etc.), which may transform, repackage, encrypt, or otherwise reformat the authorization request. Further, in practice, the authorization request may be transmitted according to any of various communication protocols. Further yet, the authorization request for the CNP transaction may contain any of various information that facilitates processing of the CNP transaction, including but not limited to payment card information.

At block 118, the acquirer platform 106 may receive the authorization request transmitted by the merchant platform 104. In turn, at block 120, the acquirer platform 106 may transmit a corresponding authorization request for the CNP transaction to an issuer platform 108 over a network-based communication path, which may comprise the network-based payment rail 110. In this respect, while the authorization requests that are received and transmitted by the acquirer platform 106 correspond to one another, it is possible that such authorization request may have different forms and/or may be sent according to different communication protocols. Further, it should be understood that the transmission of the authorization request to the issuer platform 108 may be routed through one or more intermediaries (e.g., payment processors, secured transaction systems, etc.). Further yet, the authorization transmitted by the acquirer platform 106 may contain any of various information that facilitates processing of the CNP transaction, including but not limited to payment card information.

At block 122, the issuer platform 108 may receive the authorization request from the acquirer platform 106 via the network-based payment rail 110. In turn, at block 124, the issuer platform 108 may generate an authorization response that memorializes a decision made by the issuer platform 108 of whether to approve or deny the CNP transaction. In this respect, the decision of whether to approve or deny the CNP transaction may be based on the information included in the received authorization request. For example, the issuer platform 108 may determine whether the payment card information is associated with a valid cardholder account and/or whether the CNP transaction would exceed a maximum spending limit for the cardholder account, among other possibilities.

At block 126, after generating the authorization response that memorializes the decision of whether to approve or deny the CNP transaction, the issuer platform 108 may transmit the authorization response to the acquirer platform 106 via a network-based communication path, which may comprise the network-based payment rail 110. In turn, at block 128, the acquirer platform 106 may receive the authorization response from the issuer platform 108 and then transmit a corresponding authorization response to the merchant platform 104 via a network-based communication path. In this respect, while the authorization responses that are received and transmitted by the acquirer platform 106 correspond to one another, it is possible that such authorization responses may have different forms and/or may be sent according to different communication protocols. Further, it should be understood that the transmission of the authorization response to the merchant platform 104 may be routed through one or more intermediaries (e.g., payment processors, secured transaction systems, etc.).

At block 130, the merchant platform 104 may receive the authorization response from the acquirer platform 106 and then transmit the authorization response to the client device 102. In turn, at block 132, the client device 102 may receive the authorization response from the merchant platform 104 and then present the authorization response, e.g., to the operator of the client device 102. The authorization response may be presented in visual and/or audio form, among other possibilities.

If the authorization process results in the successful authorization of the CNP transaction, a settlement process may thereafter be carried out for the CNP transaction in order to effectuate a funds transfer for the CNP transaction. For instance, such a settlement process may begin with (i) the merchant platform 104 sending a settlement request for the authorized CNP transaction (and perhaps other authorized CNP transactions) to the acquirer platform 106 over a network-based communication path and (ii) the acquirer platform 106 sending a corresponding settlement request to the issuer platform 108 over a network-based communication path, which may comprise the network-based payment rail 110. After the issuer platform 108 receives and approves the settlement request, the funds for the CNP transaction may then be transferred from the issuer platform 108 to the acquirer platform 106 via the network-based payment rail 110, the acquirer bank may deposit the proceeds from the CNP transaction into a bank account of the merchant, and the issuer bank may charge the cardholder of the purchase card for the CNP transaction.

One or more of the computing platforms within the example computing environment may also maintain a transaction log that contains stored transaction details for CNP transactions that were previously processed by the one or more of the computing platforms. For example, the merchant platform 104 may maintain a merchant-level transaction log that contains stored transaction details for CNP transactions that were previously processed by the merchant platform 104. As another example, the acquirer platform 106 may maintain an acquirer-level transaction log that contains stored transaction details for CNP transactions that were previously processed by the acquirer platform 106. As yet another example, the issuer platform 108 may maintain an issuer-level transaction log that contains stored transaction details for CNP transactions that were previously processed by the issuer platform 108. As still another example, the network-based payment rail 110 may maintain a rail-level transaction log that contains stored transaction details for CNP transactions that were previously processed through the network-based payment rail 110. In this respect, it should be understood that each of these transaction logs may differ, because each of these computing platforms may be involved in processing different (but overlapping) sets of CNP transactions.

Further, in practice, the transaction details that are stored for each CNP transaction that was previously processed by a given computing platform may comprise any of various types of transaction data elements, and examples may include: (i) a PAN number of the payment card used for the CNP transaction, (ii) a BIN number of the payment card used for the CNP transaction (e.g., a BIN11 number), (iii) an identifier of a client involved in the CNP transaction, (iv) an identifier of the issuer bank of the purchase card used for the CNP transaction, (v) an identifier of the merchant involved in the CNP transaction, (vi) a transaction amount of the CNP transaction, or (vii) an indication of a processing result of the CNP transaction, among various other possibilities.

Unfortunately, CNP transactions that are processed in the manner described above also give rise to new opportunities for fraudulent activity. One form of fraudulent activity that is increasingly common with CNP transactions is a brute-force attack (or sometimes called “card cracking” or “bot attacks”), where a fraudster uses a software program (sometimes called a “bot”) to initiate a relatively large number of fraudulent CNP transactions within a relatively short period of time in an attempt to validate payment card details that have been improperly obtained by the fraudster in some manner. For instance, such a software program may iteratively initiate CNP transactions using various different combinations of payment card details, including various different PANs, in an attempt to identify combinations of payment card details that result in successful authorizations. In turn, the fraudster may either use the identified combinations of payment card details to engage in high-level fraudulent transactions or sell the identified combinations of payment card details to other fraudsters, which may give rise to a host of negative consequences, including reputational harm, chargebacks, sales losses, and data breaches, among others.

For these and other reasons, there is a need for safeguards that protect against these types of brute-force attacks. However, given the large volumes of CNP transactions that are processed by network-based payment rails and issuer banks as well as the efforts taken by the fraudsters'software applications to obscure their fraudulent CNP transactions, it is difficult to reliably identify which CNP transactions are associated with a brute-force attack, and thus which payment card details are at risk of being used for fraudulent transactions in the future. Indeed, the network-based payment networks operated by Discover®, American Express®, Mastercard®, or Visa® may process many thousands or millions of CNP transactions per day, and the task of sorting through all of these CNP transactions to identify which of them may be associated with a brute-force attack is not something that can be practically performed by humans. Instead, the task of identifying CNP transactions associated with a brute-force attack and then implementing measures to protect against fraudulent transactions that follow from the brute-force attack requires the use of technology.

In this respect, some technology has previously been developed for the purpose of protecting against brute-force attacks. One example of such existing technology takes the form of a computing platform installed with software that monitors a number of declined CNP transactions (either by a single issuer bank or across multiple issuer banks) within a sliding window of time, and if that number of declined CNP transactions exceeds some threshold, determines that a brute-force attack has occurred. However, this existing technology suffers from several drawbacks.

First, using the number of declined CNP transactions as the sole basis for identifying a brute-force attack is not sufficiently reliable or accurate, and as a result, it can lead to both “false positives” where the software erroneously determines that a brute-force attack has occurred and “false negatives” where the software fails to identify a brute-force attack that has actually occurred. For instance, there could be circumstances where the total number of declined CNP transactions within a sliding window of time is high for legitimate reasons, such as the fact that it includes declines by certain merchants that are involved in a larger total number of CNP transactions (e.g., larger retailers) and are therefore likely have a larger number of declined CNP transactions than other merchants, but the existing technology may nevertheless incorrectly identify a brute-force attack based on that higher number of declined CNP transactions. This type of false positive is undesirable, because it typically leads to the initiation of unnecessary measures for protecting against a brute-force attack that never took place, which involves an unnecessary and inefficient use of compute resources and perhaps also the blocking of legitimate CNP transactions. On the other hand, there could be circumstances where the total number of declined CNP transactions within a sliding window of time is below the threshold, but there was nevertheless a smaller-scale brute-force attack that went unidentified by the existing technology. This type of false negative is undesirable, because it leads to an increase in the risk of fraudulent transactions, which gives rise to all of the negative consequences described above.

Second, even if the existing technology is able to reliably and accurately identify a brute-force attack by evaluating the number of declined CNP transactions within a sliding window of time, it does not include any mechanism for determining which of the declined CNP transactions appeared be involved in a brute-force attack versus which of the declined CNP transactions were initiated by legitimate means but declined for other reasons. Instead, the existing technology typically treats all declined CNP transactions as potentially being involved in a brute-force attack, and may flag certain payment card details as being suspicious despite the fact that those payment card details were used for a legitimate (albeit declined) CNP transaction. This may lead to an unnecessary and inefficient use of compute resources and perhaps also the blocking of legitimate CNP transactions.

To address these and other problems, disclosed herein is software technology for mitigating fraudulent CNP transaction activity by identifying payment card details that were potentially involved in a fraudulent activity (e.g., a brute-force attack) and then using the identified payment card details as a basis for defining logic that can be utilized to identify (and potentially block) fraudulent CNP transactions in the future.

At a high level, the disclosed software technology may involve (i) identifying a set of CNP transactions that are candidates for potential involvement in fraudulent activity (e.g., a brute force attack), which may be referred to herein as either a “candidate set of CNP transactions” or a “set of candidate CNP transactions,” (ii) for each respective CNP transaction in the candidate set, determining a respective combination of transaction-element values for a given set of transaction data elements, (iii) based on an evaluation of the respective combinations of transaction-element values determined for the CNP transactions in the candidate set, identifying at least combination of transaction-element values that is associated with a risk of fraudulent activity, which may be referred to herein as an “at-risk” combination of transaction-element values, (iv) using the identified at least one at-risk combination of transaction-element values as a basis for deploying logic for identifying CNP transactions that present a risk of fraudulent activity. Various different embodiments of this functionality are possible, which may involve the use of different functionality for identifying the candidate set of CNP transactions and/or different sets of transaction elements that are used as basis for identifying at-risk combinations of transaction-element values.

For instance, in a first embodiment, the candidate set of CNP transactions that are identified may comprise recent CNP transactions involving PANs that are within a first “PAN difference threshold” of one another (e.g., PANs that are within 50 of one another) and were used for less than a threshold number of recent CNP transactions, among other possible criteria used to identify the set of candidate CNP transactions, and the given set of transaction data elements may comprise (i) BIN number of the PAN involved in a CNP transaction (e.g., a BIN11 number), (ii) an identifier of a client involved in the CNP transaction, (iii) an identifier of a merchant involved in the CNP transaction, among other possible transaction data elements, and perhaps also (iv) an identifier of an issuer bank for the PAN involved in the CNP transaction, among other possible transaction data elements.

In a second embodiment, the candidate set of CNP transactions that are identified may comprise recent CNP transactions involving PANs that are within a second “PAN difference threshold” of one another (e.g., PANs that are within 500 of one another) and were used for less than a threshold number of recent CNP transactions, among other possible criteria used to identify the set of candidate CNP transactions, and the given set of transaction data elements may comprise (i) a BIN number of the PAN involved in a respective CNP transaction (e.g., a BIN10 number), (ii) an identifier of a client involved in the CNP transaction, (iii) one or both of a unique numeric identifier of the merchant involved in the CNP transaction (sometimes called a “merchant ID”) and/or a merchant name of the merchant involved in the CNP transaction, (iv) a transaction amount of the CNP transaction, and perhaps also (v) an identifier of an issuer bank for the PAN involved in the CNP transaction, among other possible transaction data elements.

In a third embodiment, the candidate set of CNP transactions that are identified may comprise recent CNP transactions involving PANs that were used for less than a threshold number of recent CNP transactions, among other possible criteria used to identify the set of candidate CNP transactions, and the given combination of transaction data elements may comprise (i) a BIN number of the PAN involved in a respective CNP transaction (e.g., a BIN10 number), (ii) an identifier of a client involved in the CNP transaction, (iii) one or both of a merchant ID of the merchant involved in the CNP transaction and/or a merchant name of the merchant involved in the CNP transaction, (iv) an indication of the processing result of the CNP transaction (e.g., approved, declined by financial institution, declined by payment network, non-sufficient funds, etc.), and (v) an identifier of an issuer bank for the PAN involved in the CNP transaction, among other possible transaction data elements.

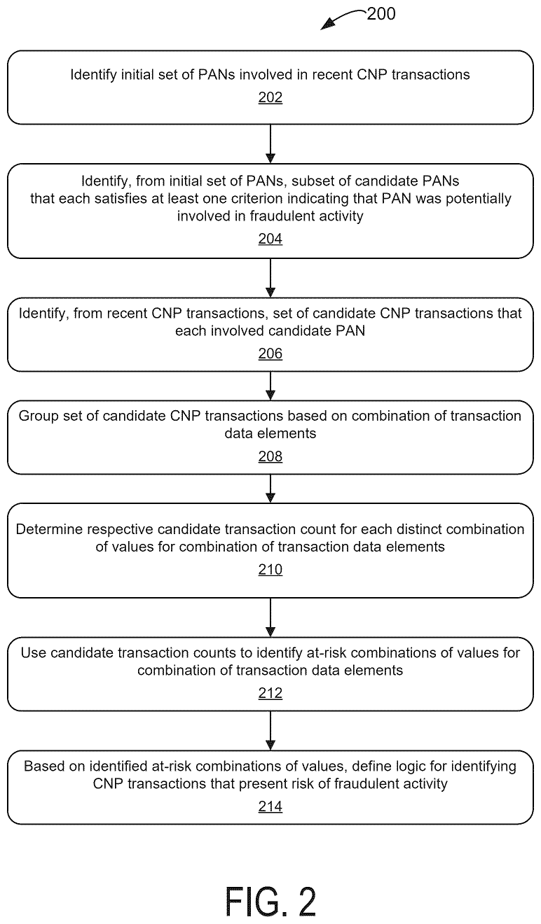

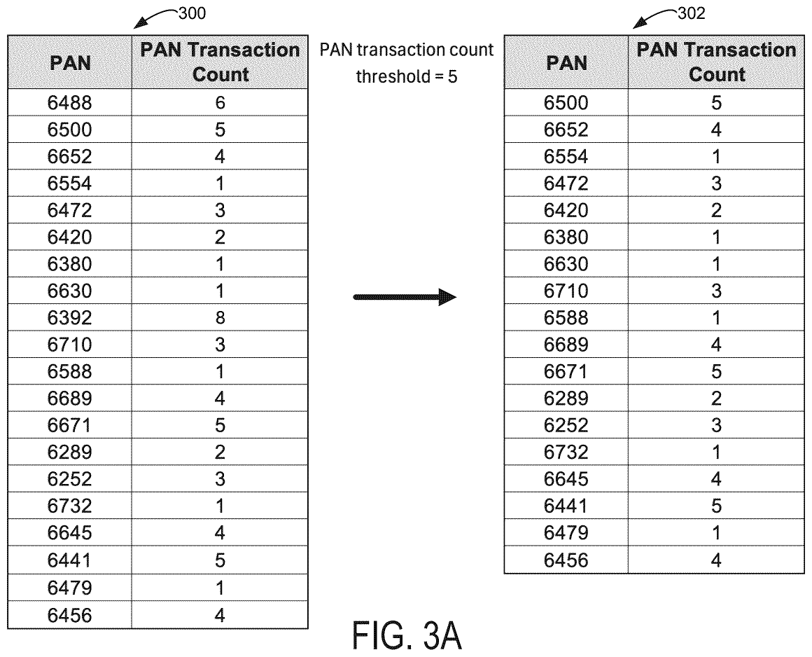

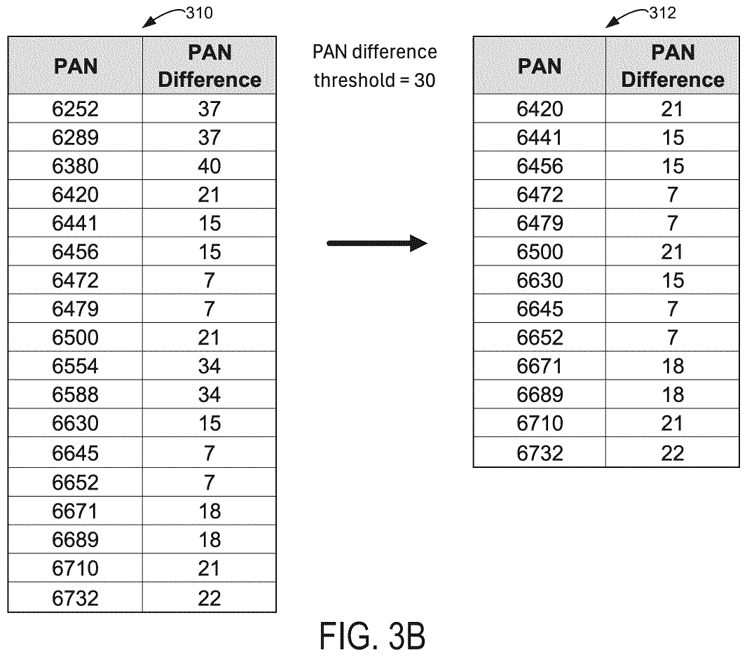

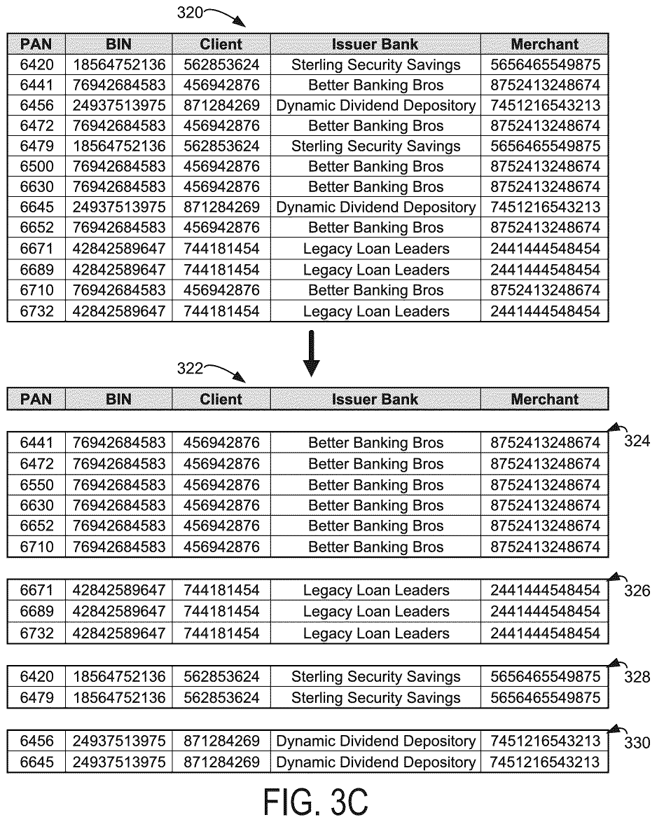

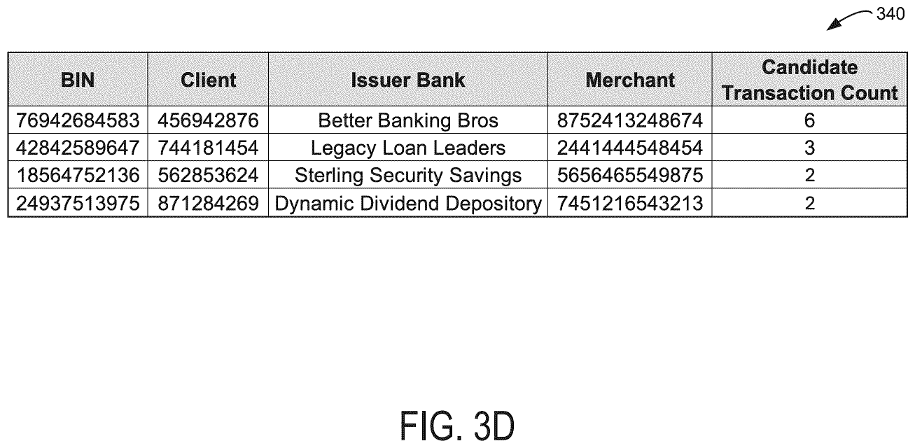

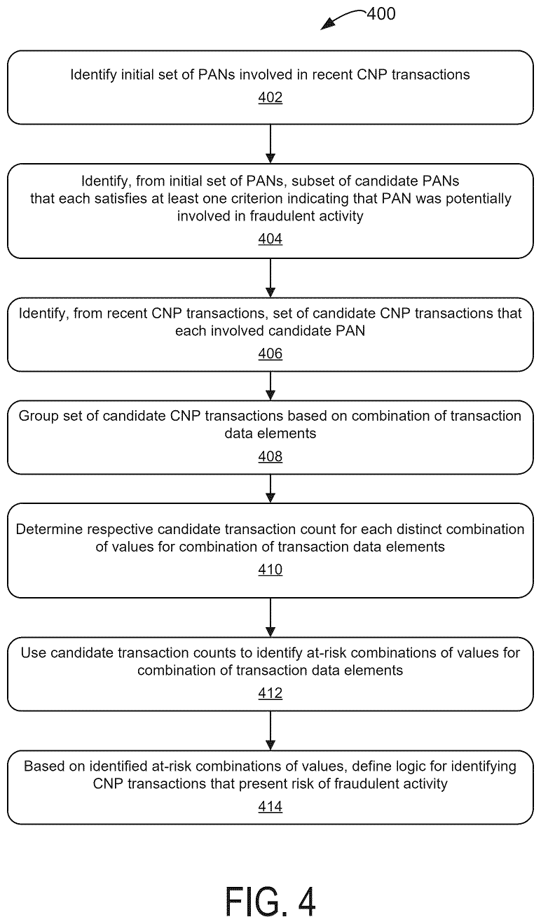

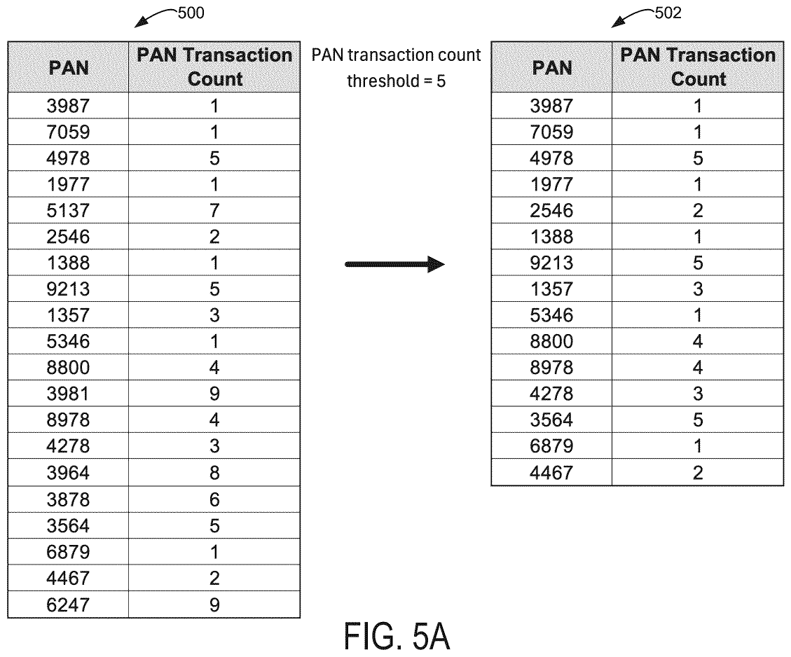

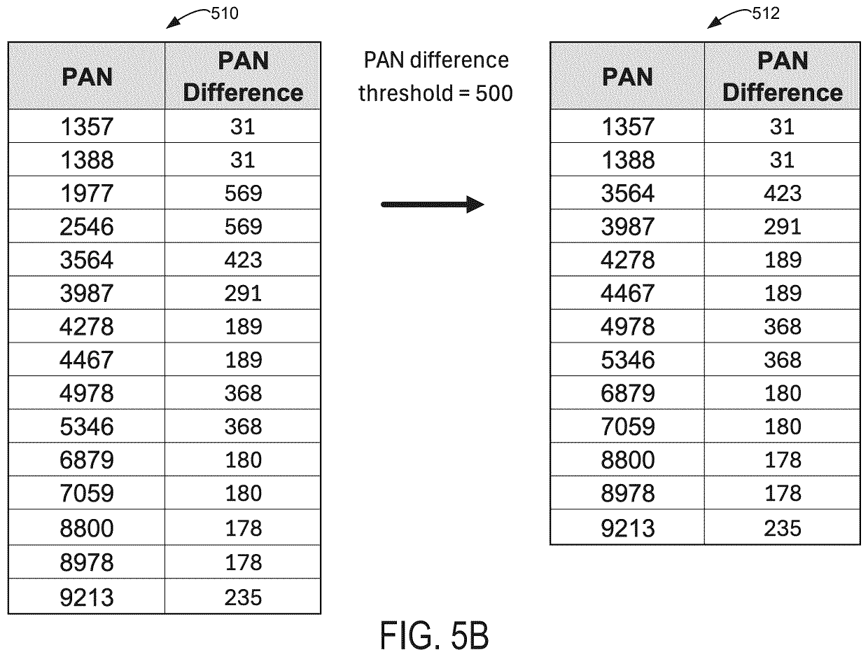

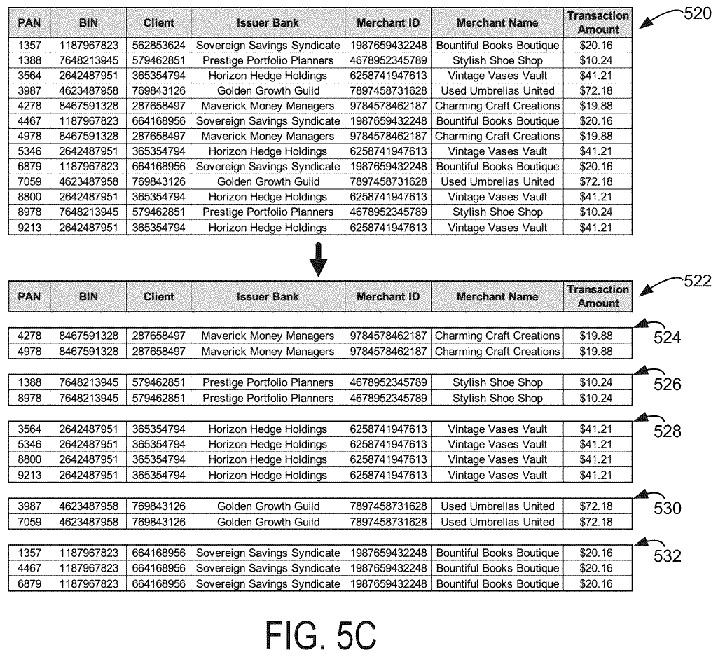

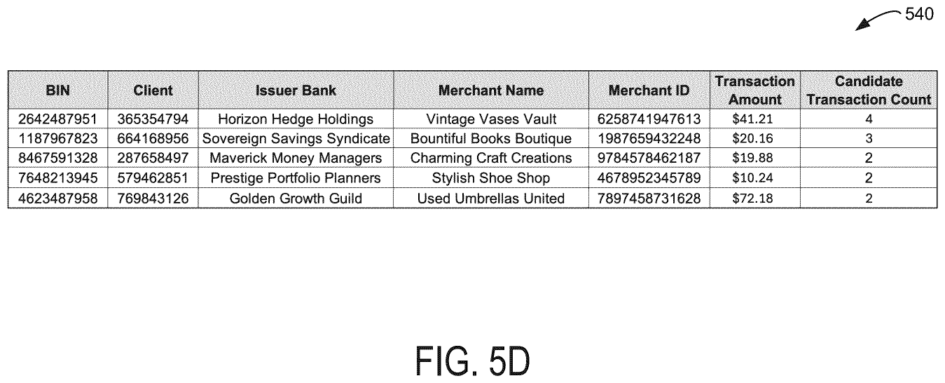

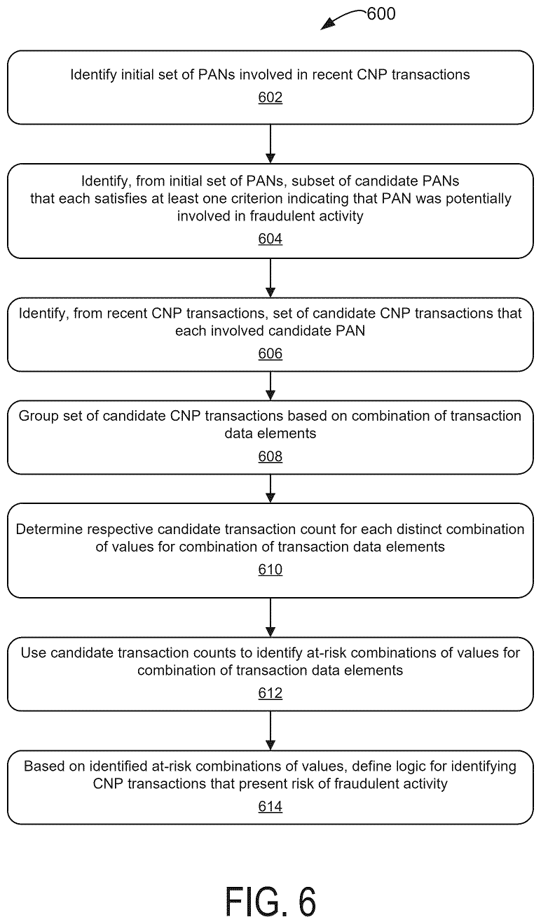

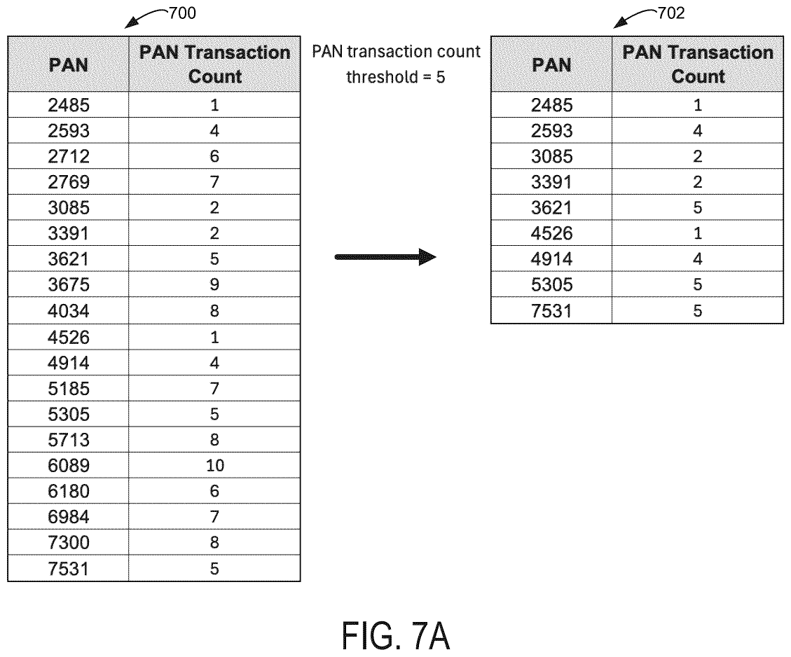

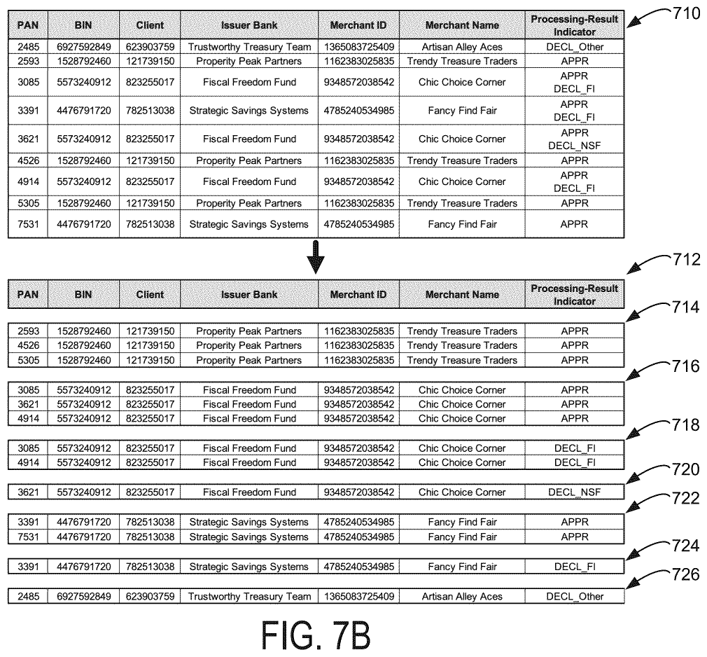

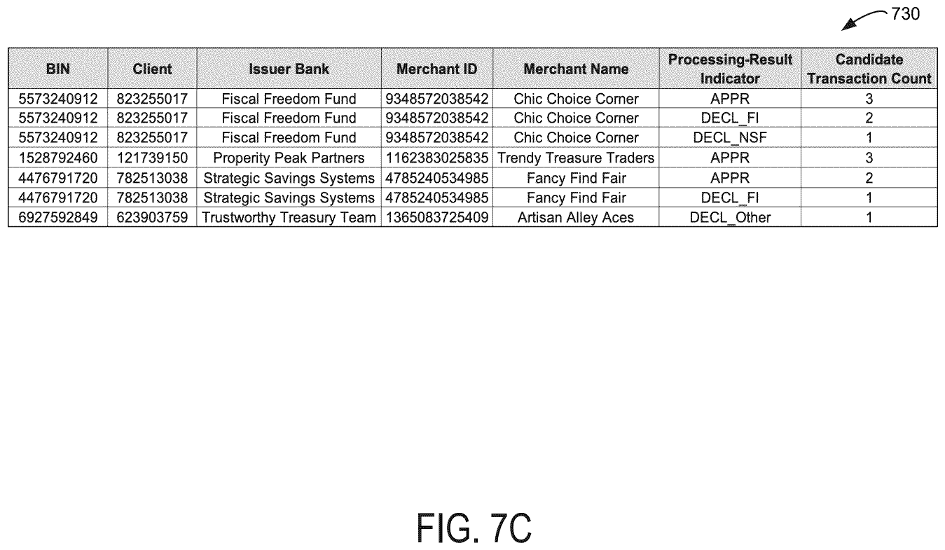

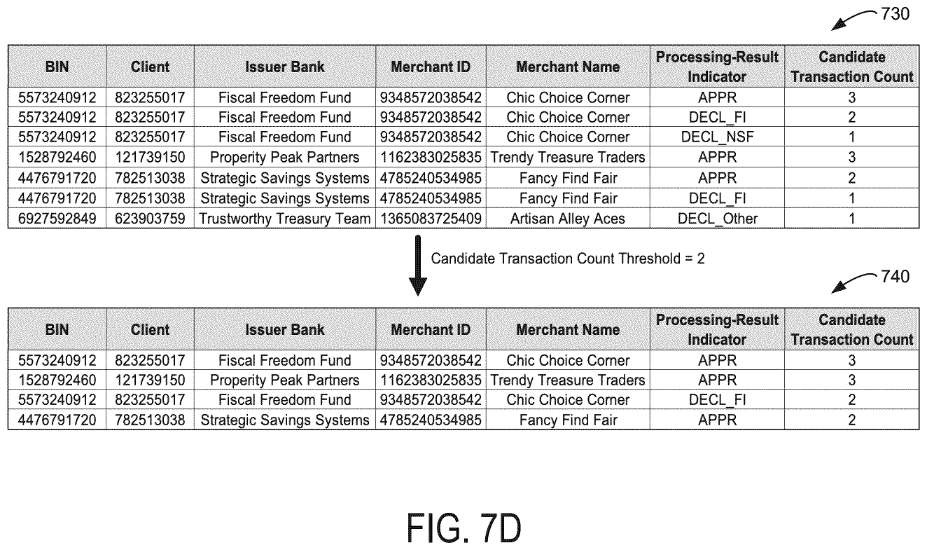

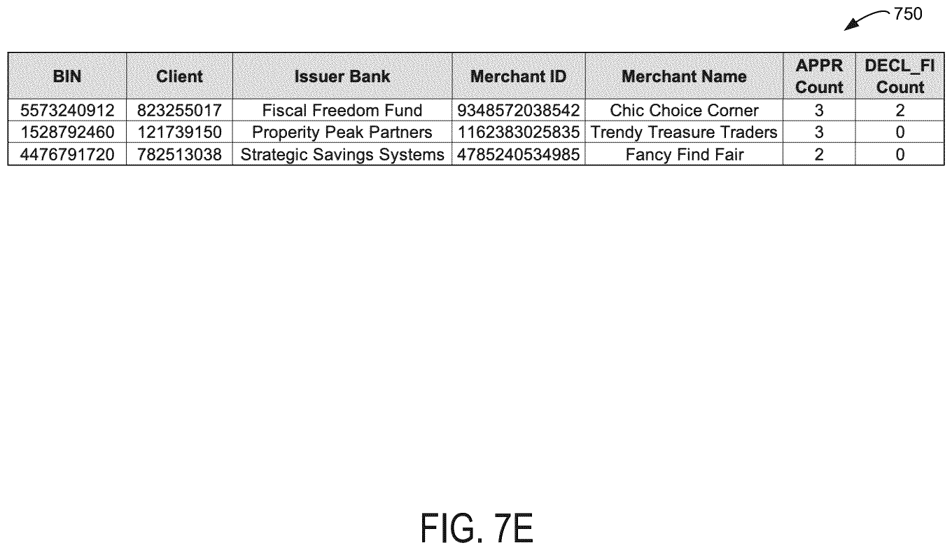

Further details regarding these three example embodiments of the disclosed technology are included below. Specifically, FIGS. 2-3 and their respective descriptions relate to the first example embodiment, FIGS. 4-5 and their respective descriptions relate to the second example embodiment, and FIGS. 6-7 and their respective descriptions relate to the third example embodiment.

The disclosed software technology improves upon existing technology for identifying and mitigating fraudulent CNP transaction activity resulting from brute-force attacks in various ways.

First, the disclosed software technology provides a more reliable and accurate framework for identifying whether a brute-force attack has occurred than existing technology. Indeed, instead of relying on the number of declined CNP transactions as the sole basis for identifying a brute-force attack, the disclosed software technology uses a given set of one or more criteria to identify a set of candidate CNP transactions that were potentially involved in a brute force attack and then performs an evaluation of those candidate CNP transactions in order to identify combinations of values for a given combination of transaction data elements that are associated with a risk of a brute force attack, which is more reliable and accurate than simply relying on the number of declined CNP transactions. As a result, the disclosed software technology avoids many of the problems described above that are associated with the higher false positive and false negative rates experienced by existing technology, including the unnecessary and inefficient use of computing resources and the blocking of legitimate CNP transactions.

Second, the disclosed software technology provides functionality for identifying particular groups of CNP transactions that were potentially involved in brute-force attacks based on an analysis of the transaction details for those CNP transactions rather than treating all declined CNP transactions (e.g., from a sliding window of time) as potentially being involved in a brute-force attack, which is a more intelligent mechanism that reduces the chances of flagging and blocking legitimate uses of payment card details.

The disclosed software technology improves upon existing technology for identifying and mitigating fraudulent CNP transaction activity resulting from brute-force attacks in other ways as well.

Turning now to FIG. 2, an example flow chart illustrating example functionality 200 for mitigating fraudulent CNP transaction activity in accordance with a first aspect of the present disclosure is shown. In practice, the example functionality 200 of FIG. 2 may be encoded in the form of program instructions that are executable by one or more processors of a computing platform, and for purposes of illustration, the example functionality 200 of FIG. 2 is described as being carried out by a given computing platform that is involved in the processing of CNP transactions, such as a computing platform of a provider of a network-based payment rail (e.g., the network-based payment rail 110) or a computing platform of an issuer bank (e.g., the issuer platform 108). However, it should be understood that the example functionality 200 of FIG. 2 may be carried out by any one or more computing platforms that are capable of being installed with software for carrying out the example functionality 200 of FIG. 2. Further, it should be understood that the example functionality 200 of FIG. 2 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 2, the example functionality 200 may begin at block 202, where the given computing platform may identify an initial set of PANs involved in CNP transactions that were processed within a recent window of time, which may be referred to herein as “recent CNP transactions.”

The recent window of time may take any of various forms. As one possibility, the recent window of time may comprise a window of time having a given duration that extends back from the time that the given computing platform initiates the functionality 200. As another possibility, the recent window of time may comprise a window of time having a given duration that is defined using a start or end point other than the time that the given computing platform initiates the functionality 200. Other possibilities may also exist.

The given duration of the recent window of time may be any period of time, and some example durations may be one or more hours, one or more days, one or more weeks, etc., although it should be understood that the recent window of time may have other durations as well, including durations less than one hour or more than one week.

Further, the given computing platform may identify the initial set of PANs involved in the recent CNP transactions in any of various ways. For instance, as one possibility, the given computing platform may begin by evaluating a transaction log for previously-processed CNP transactions that is maintained by (or otherwise accessible to) the given computing platform in order to identify CNP transactions from the recent window of time (e.g., transactions initiated via message types 1100 and/or 1200). The transaction log that is evaluated may take various forms, which could depend in part on which computing platform is installed with the software for carrying out the functionality 200. As one possible example, if the given computing platform is a computing platform associated with a given network-based payment rail, the transaction log may memorialize recent CNP transactions that were processed through the given network-based payment rail and perhaps also recent CNP transactions that were processed through other network-based payment rails (e.g., if the given network-based payment rail has access to transaction details for CNP transactions processed through other network-based payment rails). As another possible example, if the given computing platform is the computing platform of a given issuer bank, the transaction log may memorialize recent CNP transactions involving the given issuer bank and perhaps also recent CNP transactions involving other issuer banks (e.g., if the given issuer bank has access to transaction details for CNP transactions involving other issuer banks). Other examples are possible as well.

After identifying the CNP transactions from the recent window of time, the given computing platform may next identify PANs that were involved in the identified CNP transactions, which may be included as part of the transaction details for the CNP transactions contained within the transaction log. In this respect, it will be understood that some of the identified PANs may constitute a PAN that was only involved in a single recent CNP transaction, while others of the identified PANs constitute a PAN that was involved multiple recent CNP transactions.

The functionality for identifying the initial set of PANs involved in the recent CNP transactions may take various other forms as well.

At block 204, the given computing platform may identify, from the initial set of PANs, a subset of “candidate” PANs that each satisfies at least one criterion indicating that the PAN was potentially involved in fraudulent activity (e.g., a brute force attack). Such a criterion may take any of various forms.

As one possibility, the given computing platform may evaluate whether each respective PAN in the initial set of PANs satisfies a first example criterion related to a number of CNP transactions involving the respective PAN that were processed during the recent window of time, which may be referred to herein as the “PAN transaction count” for the respective PAN, and the first example criterion may define a maximum PAN transaction count that a PAN is permitted to have in order to be included in the subset of candidate PANs, which may be referred to herein as the “PAN transaction count threshold.” In this respect, any PAN from the initial set having a PAN transaction count (i.e., a number of recent CNP transactions involving the PAN) that does not exceed the PAN transaction count threshold may be eligible for inclusion in the subset of candidate PANs (subject to whether any other criterion is applied), whereas any PAN from the initial set having a PAN transaction count (i.e., a number of recent CNP transactions involving the PAN) that does exceed the PAN transaction count threshold may be excluded from the subset of candidate PANs. Notably, applying this first example criterion serves to exclude identified PANs that were involved in larger number of CNP transactions during the recent window of time, which is not a typical characteristic of a brute force attack. Rather, in a brute force attack, each PAN is typically only utilized for a smaller number of transactions (e.g., one or two transactions).

The PAN transaction count threshold may have any of various values. Some example values of the PAN transaction count threshold may range from 5-10 (e.g., if the PAN transaction count that is typically seen during a brute force attack is less than 5-10). However, it should be understood that the value of the PAN transaction count threshold may be fewer than 5 or more than 10.

Further, the function of determining whether the PANs from the initial set satisfy this first example criterion may take any of various forms. According to one possible implementation, the given computing platform may (i) determine a respective PAN transaction count for each PAN in the initial set of PANs, which may indicate how many recent CNP transactions the PAN was involved in, and then (ii) identify any PAN from the initial set having a PAN transaction count that meets the PAN transaction count threshold as a PAN that is eligible for inclusion in the subset of candidate PANs.

The function of determining whether the PANs from the initial set satisfy the first example criterion may take other forms as well.

FIG. 3A shows a simplified example to illustrate the functionality that may be carried out by the given computing platform in order to determine whether PANs from the initial set satisfy this first example criterion. For simplicity, PANs are represented in FIG. 3A, as well as other figures, by their last four digits, rather than their full length.

As discussed above, the functionality for determining whether PANs from the initial set satisfy this first example criterion may begin with the given computing platform determining a respective PAN transaction count for each PAN from the initial set. An example result of this functionality is shown in a first table 300 of FIG. 3A, which includes (i) an example list of PANs from the initial set of PANs involved in CNP transactions from a recent window of time and (ii) corresponding PAN transaction counts that each indicates a number of recent CNP transactions involving a respective PAN in the list. (While the first table 300 shows 20 PANs, it should be understood that this is a simplified example provided for illustration only, and that in practice, the initial set of PANs may include a much larger number of PANs that were involved in recent CNP transactions.) After determining the PAN transaction counts shown in the first table 300 of FIG. 3A, the given computing platform may compare each PAN's corresponding PAN transaction count to a PAN transaction count threshold, which in this simplified example is 5, in order to determine which PANs are eligible for inclusion in the subset of candidate PANs. FIG. 3A shows a second table 302 that includes an updated list of PANs resulting from this functionality. In the second table 302, the PANs having a PAN transaction count that meets the PAN transaction count threshold of 5 are listed, whereas the PANs having a PAN transaction count that exceeds the PAN transaction count threshold of 5 (e.g., the PANs ending with “6392” and “6488” having a PAN transaction count value of 8 and 6, respectively) are not listed. The PANs shown in the second table 302 are then eligible for inclusion as part of the subset of candidate PANs (subject to whether any other criterion is applied).

Returning to block 204 of FIG. 2, as another possibility, the given computing platform may evaluate whether each respective PAN in the initial set of PANs satisfies a second example criterion related to a numeric difference between the respective PAN and a next-closest PAN (numerically speaking) from the initial set, which may be referred to as the “PAN difference” for the respective PAN, and the second example criterion may define a maximum PAN difference that a PAN is permitted to have in order to be included in the subset of candidate PANs, which may be referred to herein as a “PAN difference threshold.” In this respect, any PAN from the initial set of PANs having a PAN difference (i.e., a numeric difference to a next-closest PAN from the initial set) that does not exceed the PAN difference threshold may be eligible for inclusion in the subset of candidate PANs, whereas any PAN from the initial set of PANs having a PAN difference that does exceed the PAN difference threshold may be excluded from the subset of candidate PANs. Notably, this second example criterion is based on an observation that, in a brute force attack, CNP transactions are typically initiated using blocks of PANs that follow a particular numeric pattern (e.g., every fourth PAN, every eighth PAN, etc.) and thus have a smaller PAN difference than would otherwise be expected for a PAN involved in a legitimate CNP transaction.

The PAN difference threshold utilized as part of this process may have any of various values. Some example values of the PAN difference threshold may comprise any value within a range between 20-50 (e.g., if the PAN difference that is typically seen during a brute force attack is less than 20-50). However, it should be understood that the value of the PAN difference threshold may be fewer than 20 or more than 50.

Further, the function of determining whether the PANs from the initial set satisfy this second example criterion may take any of various forms. According to one possible implementation, the given computing platform may begin by placing the initial set of PANs into a sequentially-ordered list, such as an ascending-ordered list or a descending-ordered list, and may then evaluate the sequentially-ordered list to determine which PANs have a PAN difference that do not exceed the PAN difference threshold (and are therefore eligible for inclusion in the subset of candidate PANs) and which PANs have a PAN difference that does exceed the PAN difference threshold (and are therefore excluded from the subset of candidate PANs). This function may take various forms.

As one possible example, the given computing platform may start by determining a respective PAN difference for each respective PAN in the sequentially-ordered list by calculating a numeric difference between the respective PAN and a next-closest PAN in the sequentially-ordered list, which will be the PAN that either immediately precedes or immediately follows the respective PAN within the sequentially-ordered list. In turn, the given computing platform may compare each respective PAN's respective PAN difference to the PAN difference threshold to determine whether the respective PAN is eligible for inclusion as a candidate PAN.

As another possible example, the given computing platform may start by calculating a numeric difference between each respective PAN in the sequentially-ordered list and the PAN that immediately precedes the respective PAN within the sequentially-ordered list (except for the first PAN in the list, which does not have an immediately-preceding PAN). In turn, the given computing platform may compare each respective PAN's numeric difference with the immediately-preceding PAN to the PAN difference threshold and then either (i) identify both the respective PAN and the immediately-preceding PAN for potential inclusion in the subset of candidate PANs if that numeric difference does not exceed the PAN difference threshold or (ii) move to the next PAN in the list if the numeric difference exceeds the PAN difference threshold. In this respect, it should be understood that the respective PAN could still be identified for potential inclusion in the subset of candidate PANs because it will be the immediately-preceding PAN for the next PAN, but if the next PAN's respective numeric difference also exceeds the PAN difference threshold, then the respective PAN will be excluded from the subset of candidate PANs.

The function of determining whether the PANs from the initial set satisfy the second example criterion may take other forms as well.

FIG. 3B shows a simplified example to illustrate the functionality that may be carried out by the given computing platform in order to determine whether PANs from the initial set satisfy this second example criterion.

As discussed above, the functionality for determining whether PANs from the initial set satisfy this second example criterion may begin with the given computing platform arranging the initial set of PANs into a sequentially-ordered list and determining PAN differences for the PANs within the sequentially-ordered list. An example result of this functionality is shown in a first table 310 of FIG. 3B, which includes (i) an example sequentially-ordered list of PANs and (ii) corresponding PAN differences that each indicates a numeric difference between a respective PAN and a next-closest PAN in the sequentially-ordered list (which may be the PAN immediately above or immediately below the respective PAN within the list).

After determining the PAN differences shown in the first table 310 of FIG. 3B, the given computing platform may compare each PAN's corresponding PAN difference to a PAN difference threshold, which in this simplified example is 30, in order to determine which PANs are eligible for inclusion in the subset of candidate PANs. FIG. 3B shows a second table 312 that includes an updated list of PANs resulting from this functionality. In the second table 312, the PANs having a PAN difference that meets the PAN difference threshold of 30 are listed, whereas the PANs having a PAN difference that exceeds the PAN difference threshold (e.g., the PANs ending with “6252,” “6289,” “6380,” “6554,” and “6588” having a PAN difference of 37, 37, 40, 34, and 34, respectively) are not listed. The PANs shown in the second table 312 are then eligible for inclusion as part of the subset of candidate PANs (subject to whether any other criterion is applied).

Returning again to block 204 of FIG. 2, instead of the second example criterion related to whether the PANs in the initial set have PAN differences that do not exceed a PAN difference threshold, the given computing platform may evaluate which PANs in the initial set satisfy a third example criterion related to whether the PAN differences of any PANs from the initial set follow a given pattern. For instance, after sequentially ordering the initial set of PANs and determining the PAN differences of the PANs in the initial set, the given computing platform may determine whether there is any sequence of PANs having PAN differences that follow a numeric pattern, such as PAN differences having the same value (e.g., four, six, eight) over the course of multiple PANs or PAN differences that change over the course of multiple PANs in a way that follows a pattern.

The criterion that is utilized by the given computing platform to identify the candidate PANs may take other forms as well.

Further, in accordance with the present disclosure, the given computing platform may be configured to either utilize a single criterion to identify the candidate PANs (e.g., the second example criterion) or utilize multiple criteria identify the candidate PANs. For instance, in one implementation of utilizing multiple criteria, the given computing platform may utilize both the first example criterion and the second example criterion to identify the candidate PANs. In such an implementation, the given computing platform may start by identifying a list of possible candidate PANs using the first example criterion and then further filter that list of possible candidate PANs using the second example criterion, or the given computing platform may start by identifying a list of possible candidate PANs using the second example criterion and then further filter that list of possible candidate PANs using the first example criterion, among other possibilities.

The function of identifying the subset of candidate PANs may take other forms as well.

At block 206, the given computing platform may identify, from the recent CNP transactions, a set of “candidate” CNP transactions that each involved a candidate PAN.

The given computing platform may identify the set of candidate CNP transactions that each involved a candidate PAN in any of various ways, and in at least some implementations, the given computing platform may perform this function by (i) evaluating a transaction log that is maintained by (or otherwise accessible to) the given computing platform in order to identify recent CNP transactions (i.e., CNP transactions from the recent window of time) that involved one of the candidate PANs, and (ii) including the identified CNP transactions in the set of candidate CNP transactions. Notably, when carrying out this functionality, it is possible that the given computing platform may identify multiple recent CNP transactions that involved that same candidate PAN, and the given computing platform may function to either (i) separately include all of those multiple recent CNP transactions in the set of candidate CNP transactions or (ii) only include a subset of those multiple recent CNP transactions in the set of candidate CNP transactions (e.g., by filtering out “duplicate” CNP transactions that have the same combination of relevant transaction details). The function of identifying the set of candidate CNP transactions that each involved a candidate PAN may take other forms as well.

At block 208, the given computing platform may group the set of candidate CNP transactions based on a combination of transaction data elements, which may include a given subset of the transaction data elements from the various types of transaction data elements previously described. For instance, as one possibility, the set of candidate CNP transactions may be grouped based on a combination of transaction data elements comprising (i) a BIN number of the PAN involved in a CNP transaction (e.g., a BIN11 number), (ii) an identifier of a client involved in the CNP transaction, (iii) an identifier of the merchant involved in the CNP transaction, and optinally also (iv) an identifier of the issuer bank for the PAN involved in the CNP transaction. However, the set of candidate CNP transactions could be grouped based on other combinations of transaction data elements as well.

The given computing platform may group the candidate CNP transactions based on the combination of transaction data elements in various ways. According to one implementation, the given computing platform may start by determining, for each candidate CNP transaction, a respective combination of values for the combination of transaction data elements. The respective combination of values determined for each candidate CNP transaction may take the form of an ordered listing of values for the combination of transaction data elements. In practice, the values may be ordered in various ways. One possible order for the combinations of values may take the form of “BIN, Client, Issuer, and Merchant,” such that the respective combination of values determined for each candidate CNP transaction may comprise, in order, (i) a respective BIN number of the respective PAN involved in the candidate CNP transaction (e.g., a BIN11 number), (ii) a respective identifier of the respective client involved in the candidate CNP transaction, (iii) a respective identifier of the respective issuer bank for the respective for the PAN involved in the candidate CNP transaction, and (iv) a respective identifier of the respective merchant involved in the candidate CNP transaction. Various other orders for the combinations of values may also exist.

After determining the respective combinations of values for the candidate CNP transactions, the given computing platform may place the candidate CNP transactions into a sorted list that is sorted according to the respective combinations of values. In this respect, the ordering of the respective combinations of values may dictate the sorting criteria for the candidate CNP transactions. For instance, the first transaction data element included in each respective combination of values (e.g., BIN number) may serve as the first sorting criterion for the candidate CNP transactions, the second transaction data element included in each respective combination of values (e.g., client identifier) may serve as the second sorting criterion for the candidate CNP transactions, and so on. However, in other implementations, the candidate CNP transactions may be represented and arranged in other manners.

After placing the candidate CNP transactions into the sorted list that is sorted according to the respective combinations of values, the given computing platform may break the sorted list into a set of groups by treating each distinct combination of values as a different group. In other words, candidate CNP transactions having the same combination of values for the combination of transaction data elements (e.g., the same BIN number, client identifier, issuer identifier, and merchant identifier) may be placed into the same group, whereas candidate CNP transactions having different combinations of values for the combination of transaction data elements may be placed into different groups. As a result, the given computing platform may create a respective group of candidate CNP transactions for each distinct combination of values for the combination of transaction data elements.

The function of grouping the candidate CNP transactions based on the combination of transaction data elements may take other forms as well.

While the foregoing describes an implementation in which the candidate CNP transactions are grouped based on one particular combination of transaction data elements, in other implementations, the given computing platform may group the set of candidate CNP transactions based on two or more different combinations of transaction data elements. For instance, the given computing platform may group the set of candidate CNP transactions based on a first combination of transaction data elements, which may produce a first set of groups, and may separately group the set of candidate CNP transactions based on a second combination of transaction data elements that differs from the first combination of transaction data elements, which may produce a second set of groups. Along similar lines, the given computing platform may group the set of candidate CNP transactions into more than two sets of groups, based on more than two combinations of transaction data elements. In this way, the set of candidate CNP transactions may be grouped together in different ways, which may allow the given computing platform to recognize additional combinations of transaction data element values that are associated with fraudulent activity.

The different combinations of transaction data elements that are used to produce the different sets of groups of the candidate CNP transactions may take any of various forms. For instance, as one possibility, two different combinations of transaction data elements may include the same types of data elements (e.g., a BIN number, a client identifier, an issuer bank identifier, and a merchant identifier), but the form of one or more of these data elements may differ. For example, both combinations of transaction data elements may include an identifier of a merchant involved in a respective candidate CNP transaction, but the merchant identifier included in one of the combinations of transaction data elements may take the form of a unique numeric identifier of the merchant (sometimes called a “merchant ID”), whereas the merchant identifier included in the other combination of transaction data elements may take the form of a name of the merchant. Other examples may also exist.

FIG. 3C shows a simplified example to illustrate the functionality that may be carried out by the given computing platform in order to group a set of candidate CNP transactions based on an example combination of transaction data elements that consists of a BIN11 number, a client identifier, an issuer bank identifier, and a merchant identifier.

As discussed above, the functionality for grouping the set of candidate CNP transactions may begin with the given computing platform determining, for each candidate CNP transaction, a respective combination of values for the combination of transaction data elements. An example result of this functionality is shown in a table 320 of FIG. 3C. Each row of the table 320 represents a respective candidate CNP transaction, and each column of the table 320 represents a respective transaction data element, including (i) a PAN number involved in a respective CNP transaction, (ii) a BIN number of the PAN involved in the CNP transaction (e.g., a BIN11 number), (iii) an identifier of a client involved in the CNP transaction, (iv) an identifier of the issuer bank for the PAN involved in the CNP transaction, and (v) an identifier of the merchant involved in the CNP transaction. The PAN column is included for continuity with FIGS. 3A and 3B, although as noted above, PANs are not included in the example combination of transaction data elements.

After determining the information shown in the table 320 of FIG. 3C, the given computing platform may place the candidate CNP transactions into a sorted list that is sorted according to the respective combinations of values and then break the sorted list into a set of groups by treating each distinct combination of values as a different group. FIG. 3C shows the result of this functionality, which is a set of groups 322 that includes a respective group for each distinct combination of values. As shown, the set of groups 322 includes: (i) a first group 324 including the candidate CNP transactions that have a combination of values comprising (a) a BIN11 value of “76942684583,” (b) a client identifier value of “456942876,” (c) an issuer bank identifier value of “Better Banking Bros,” and (d) a merchant identifier value of “8752413248674,” (ii) a second group 326 including the candidate CNP transactions that have a combination of values comprising (a) a BIN11 value of “42842589647,” (b) a client identifier value of “744181454,” (c) an issuer bank identifier value of “Legacy Loan Leaders,” and (d) a merchant identifier value of “2441444548454,” (iii) a third group 328 including the candidate CNP transactions that have a combination of values comprising (a) a BIN11 value of “18564752136,” (b) a client identifier value of “562853624,” (c) an issuer bank identifier value of “Sterling Security Savings,” and (d) a merchant identifier value of “5656465549875,” and (iv) a fourth group 330 including the candidate CNP transactions that have a combination of values comprising (a) a BIN11 value of “24937513975,” (b) a client identifier value of “871284269,” (c) an issuer bank identifier value of “Dynamic Dividend Depository,” and (d) a merchant identifier value of “7451216543213.”

The functionality of grouping a set of candidate CNP transactions based on an example combination of transaction data elements may take other forms as well.

Returning again to FIG. 2, at block 210, the given computing platform may determine a respective number of candidate CNP transactions included in each group of candidate CNP transactions determined at block 208, which provides a respective “candidate transaction count” for each distinct combination of values for the combination of transaction data elements that indicates how many candidate CNP transactions having the same distinct combination of values were processed during the recent window of time.

For instance, the given computing platform may determine a first number of candidate CNP transactions included in a first group of candidate CNP transactions having a first distinct combination of values for the combination of transaction data elements (e.g., a first distinct combination of BIN, Client, Issuer, and Merchant values), a second number of candidate CNP transactions included in a second group of candidate CNP transactions having a second distinct combination of values for the combination of transaction data elements (e.g., a second distinct combination of BIN, Client, Issuer, and Merchant values), and so on for the other groups determined at block 208 (each of which corresponds to a different combination of values for the combination of transaction data elements). In this respect, the first number of candidate CNP transactions constitutes a candidate transaction count for the first distinct combination of values for the combination of transaction data elements, the second number of candidate CNP transactions constitutes a candidate transaction count for the second distinct combination of values for the combination of transaction data elements, and so on.

As noted above, in some implementations, the given computing platform may also group the candidate CNP transactions into multiple sets of groups, e.g., based on different combinations of transaction data elements. In such implementations, the given computing platform may perform the operations of block 210 for each respective set of groups, which may produce multiple sets of candidate transaction counts for multiple sets of distinct combinations of transaction values.

FIG. 3D shows a simplified example to illustrate the functionality that may be carried out by the given computing platform in order to determine the candidate transaction counts for the distinct combinations of values for the combination of transaction data elements.

As discussed above, the given computing platform may carry out this functionality by determining the respective number of candidate CNP transactions in each group of candidate CNP transactions that was previously determined as discussed above in connection with block 208. An example result of carrying out this functionality with respect to the example set of groups 322 of FIG. 3C is shown in a table 340 of FIG. 3D. Each row of the table 340 represents a respective group of the example set of groups 322 of FIG. 3C and corresponds to a distinct combination of values for the example combination of transaction data elements referenced in FIG. 3C—namely, a combination consisting of a BIN11 number, a client identifier, an issuer bank identifier, and a merchant identifier. The table 340 also includes (i) a set of columns showing each group's distinct combination of values for the combination of transaction data elements, and (ii) a column showing the respective number of candidate CNP transactions included in each group of the example set of groups 322, which provides the candidate transaction count for each group's distinct combination of values. As shown, the rows of the table 340 have candidate transaction counts of 6, 3, 2, and 2, respectively, indicating that the distinct combinations of values show in those rows were involved in 6, 3, 2, and 2 candidate CNP transactions, respectively.

The function of determining the candidate transaction counts for the distinct combinations of values for the combination of transaction data elements may take other forms as well—including but not limited to the possibility that the given computing platform may determine such candidate transaction counts without first placing the candidate CNP transactions into groups corresponding to distinct combinations of values. For instance, after identifying the set of candidate transactions, the given computing platform may carry out some other functionality for identifying distinct combinations of values for the combination of transaction data elements and determining respective candidate transaction counts for the distinct combinations of values (e.g., based on evaluating the transaction details for the candidate transactions) that does not necessarily involve arranging the candidate transactions into groups.

Returning again to FIG. 2, at block 212, the given computing platform may use the candidate transaction counts determined at block 210 to identify combinations of transaction element values that are associated with a risk of fraudulent activity (e.g., brute force attacks), which may be referred to herein as “at-risk” combinations of values. This function may take various forms.

For instance, as one possibility, the given computing platform may identify the at-risk combinations of values by determining which combinations of values for the combination of transaction data elements have a candidate transaction count that exceeds (or is at least equal to) a threshold number of candidate transactions having the same distinct combination of values for the combination of transaction data elements, which may be referred to as the “candidate transaction count threshold.” Notably, this criterion for identifying at-risk combinations of values is based on an observation that the number of candidate CNP transactions sharing the same given combination values for the combination of transaction data elements is typically indicative of a level of risk that the given combination of values is being used as part of a brute force attack—where higher numbers of candidate CNP transactions sharing the same given combination of values are more likely to indicate that the given combination of values is being used as part of a brute force attack and lower numbers of candidate CNP transactions sharing the same given combination values are less likely to indicate that the given combination of values is being used as part of a brute force attack.

The candidate transaction count threshold may have any of various values. Some example values of the candidate transaction count threshold may range between 2-100. However, it should be understood the candidate transaction count threshold could have other values as well.

To illustrate with the simplified example of FIG. 3D, if the candidate transaction count threshold has a value of 3, the given computing platform may identify the first and second combinations of values shown in the table 340 as being at-risk combinations of values, based on their respective candidate transaction counts of 6 and 3 being greater than or equal to the candidate transaction count threshold.

As noted above, in some implementations, the given computing platform may also group the candidate CNP transactions into multiple sets of groups based on different combinations of transaction data elements and then determine candidate transaction counts for the different sets of distinct combinations of values that define the different sets of groups. In such implementations, the given computing platform may then perform the operations of block 212 for each respective set of groups, which may result in the identification of multiple sets of at-risk combinations of values. Further, in such implementations, the given computing platform may thereafter merge the multiple sets of at-risk combinations of values into a single, unified set of at-risk combinations of values. This function may take various forms.

As one possibility, the given computing platform may start by evaluating at-risk combinations of values of different sets of at-risk combinations of values to determine whether any at-risk combinations of values represent the same set of transaction details in different ways, which may be referred to herein as “matching” at-risk combinations. The given computing platform may determine that two different at-risk combinations of values represent the same set of transaction details in different ways if the two at-risk combinations include the same types of transactional data elements and the two values for each type of transactional data element represent the same information - which may be the case if either (i) the two values themselves are the same (e.g., the same BIN11 number) (ii) the two values differ from one another but constitute two different representations the same information (e.g., two different forms of identifiers that identify the same client, the same merchant, the same financial institution, etc. in different ways, such as by numerical identifier in one combination and name in the other combination).

To illustrate with an example, a first set of at-risk combinations of values may include an at-risk combination of values comprising a merchant ID value of “8752413248674,” among other values for a first combination of transaction data elements, and a second set of at-risk combinations of values may include an at-risk combination of values comprising a merchant name value of “Amazon Web Services,” among other values for a second combination of transaction data elements. Assuming that the other transactional data elements and values of these two at-risk combinations of values are the same, the given computing platform may evaluate whether the “8752413248674” merchant ID value and the “Amazon Web Services” merchant name value represent the same merchant (e.g., based on referencing a list of corresponding merchant names and IDs), and if so, the given computing platform may determine that the two different at-risk combinations of values represent the same set of transaction details in different ways.

To the extent that the given computing platform identifies matching at-risk combinations of values that represent the same set of transaction details in different ways, the given computing platform may then define a single at-risk combination of values that represents the matching at-risk combinations of values into. For example, if the given computing platform identifies matching at-risk combinations of values that have the same BIN value, the same client identifier, the same issuer bank identifier, and different merchant identifiers that represent the same merchant using merchant ID versus merchant name, the given computing platform may then either (i) select one of the two matching at-risk combinations of values (e.g., the combination with the merchant ID versus the combination with the merchant name) to include in the unified set of at-risk combinations or (ii) concatenate the two matching at-risk combinations of values into a new at-risk combination of values that includes both the merchant ID and the merchant name.

The function of merging the multiple sets of at-risk combinations of values into a single, unified set of at-risk combinations of values may take other forms as well.

Further, in some implementations, the given computing platform may exclude certain combinations of values from being identified as at-risk combinations of values even if such combinations would otherwise be identified as an at-risk combination of values based on the criteria described above. For instance, the given computing platform may be configured to exclude combinations of values that identify a trusted client even if those combinations of values have candidate transaction counts that exceed the candidate transaction count threshold, among other examples.

At block 214, the given computing platform may, based on the identified at-risk combinations of values, define logic for identifying CNP transactions that present a risk of fraudulent activity. In general, the logic for identifying CNP transactions that present a risk of fraudulent activity may take the form of a set of conditional statements, where each such conditional statement comprises a respective combination of conditions for identifying CNP transactions that present a risk of fraudulent activity. For instance, the logic for identifying future CNP transactions that present a risk of fraudulent activity may include a first conditional statement comprising a first combination of conditions for identifying CNP transactions that present a risk of fraudulent activity, a second conditional statement comprising a second combination of conditions for identifying CNP transactions that present a risk of fraudulent activity, and so on. Additionally, in some implementations, each conditional statement may comprise a respective action that is to be performed if the respective combination of conditions is met by a CNP transaction to which the logic is applied, which may be to identify (or “flag”) the CNP transaction as an “at-risk” transaction and perhaps also to take some protective action such as blocking the CNP transaction, issuing an alert, initiating a secondary process for validating the CNP transaction, or the like. However, in other implementations, each conditional statement may simply take the form of a combination of conditions, and the action to be performed may be defined separately from the conditional statements. For example, the logic identifying CNP transactions that present a risk of fraudulent activity may be defined to include a global action that is to be performed if any one of the conditional statements is met by a CNP transaction to which the logic is applied.

The function of defining the logic for identifying CNP transactions that present a risk of fraudulent activity based on the identified at-risk combinations of values may take various forms, and in at least some implementations, the given computing platform may define a respective conditional statement that corresponds to each of the identified at-risk combination of values. For instance, the given computing platform may define a first conditional statement that corresponds to a first identified at-risk combination of values (e.g., a first at-risk combination of BIN, Client, Issuer, and Merchant values), a second conditional statement that corresponds to a second identified at-risk combination of values (e.g., a second at-risk combination of BIN, Client, Issuer, and Merchant values), and so on. In this respect, a conditional statement that corresponds to an identified at-risk combination of values may take any of various forms.

As one possibility, a conditional statement that corresponds to an identified at-risk combination of values may comprise a set of conditions for evaluating whether CNP transactions involve the at-risk combination of values themselves. For example, if the at-risk combination of values consists of a given BIN11 value, a given Client ID value, a given Issuer ID value, and a given Merchant ID value, the given computing platform may define a conditional statement comprising a set of conditions for identifying any CNP transactions having the same given BIN11 value, the same given Client ID value, the same given Issuer ID value, and the same given Merchant ID value. Or in other words, the set of conditions may take the form of {BIN11=X1 AND ClientID=X2 AND IssuerID=X3 AND MerchantID=X4), where X1 is the given BIN11 value, X2 is the given Client ID value, X3 is the given Issuer ID value, and X4 is the given Merchant ID value. Many other examples are possible as well.

As another possibility, a conditional statement that corresponds to an identified at-risk combination of values may comprise a set of conditions that are defined based on the at-risk combination of values but do not evaluate whether CNP transactions involve the at-risk combination of values themselves. For example, if the at-risk combination of values consists of a given BIN11 value, a given Client ID value, a given Issuer ID value, and a given Merchant ID value, the given computing platform may define a conditional statement comprising a condition specifying a given BIN10 value that corresponds to the given BIN11 value, along with other conditions specifying the values of the other transactional data elements included in the at-risk combination of values (e.g., the given Client ID, given Issuer ID, and given Merchant ID values). Or in other words, the set of conditions may take the form of {BIN10=X1 AND ClientID=X2 AND IssuerID=X3 AND MerchantID=X4}, where X1 is the BIN10 value that corresponds to the given BIN11 value, X2 is the given Client ID value, X3 is the given Issuer ID value, and X4 is the given Merchant ID value. In practice, this use of a BIN10 condition instead of a BIN11 condition may result in the identification of a larger number of at-risk transactions (because a BIN10 value encompasses a wider range of PANs), which may be desirable in some scenarios. Many other examples are possible as well.

As yet another possibility, a conditional statement that corresponds to an identified at-risk combination of values may comprise a set of conditions that are defined based on some of the values included in the at-risk combination of values but not others. For example, if the at-risk combination of values consists of a given BIN11 value, a given Client ID value, a given Issuer ID value, and a given Merchant ID value, the given computing platform may define a conditional statement comprising a set of conditions specifying the given BIN11 value, the given Client ID value, and the given Merchant ID value, but not the given Issuer ID value. Or in other words, the set of conditions may take the form of {BIN11=X1 AND ClientID=X2 AND MerchantID=X3}, where X1 is the given BIN11 value, X2 is the given Client ID value, and X3 is the given Merchant ID value. Many other examples are possible as well.

In at least some implementations, the logic may also include or be associated with expiration times for the conditional statements that are defined as part of the logic. For instance, each conditional statement may have an associated expiration time that indicates how long the conditional statement should remain “active” and be used to identify CNP transactions that present a risk of fraudulent activity. Such an expiration time could take any of various forms, examples of which may include one or more hours, days, weeks, etc. from when the conditional statement is first deployed.

The logic that is defined based on the identified at-risk combinations of values may take other forms as well.

After defining the logic for identifying CNP transactions that present a risk of fraudulent activity, the given computing platform may then cause one or more computing platforms involved in processing CNP transactions (possibly including the given computing platform itself) to deploy the logic for identifying CNP transactions that present a risk of fraudulent activity. The one or more computing platforms may then begin utilizing the logic to evaluate new CNP transactions that are being processed and thereby identify CNP transactions that present a risk of fraudulent activity.

For instance, a computing platform that is configured to execute the defined logic may evaluate whether each new CNP transaction being processed meets any of the conditional statements included in the defined logic (e.g., by checking whether any combination of conditions has been satisfied), and if so, the computing platform may identify the future CNP transaction as an “at-risk” transaction and perform some protective action such as blocking the new CNP transaction, issuing an alert, initiating a secondary process for validating the new CNP transaction, or the like. In this respect, as noted above, the particular action that is carried out by the computing platform when a given conditional statement is met may be defined as part of the given conditional statement itself or may be defined separately from the given conditional statement (e.g., a global action that is to be performed by the computing platform when any one of the conditional statements is met). The functional of utilizing the defined logic to evaluate new CNP transactions being processed may take other forms as well.

Further, in implementations where the conditional statements included in the defined logic have associated expiration times, a computing platform that is configured to execute the defined logic may function to deactivate conditional statements when their associated expiration times are reached. For instance, if a given conditional statement has an associated expiration time that is defined to be four hours from when the given conditional statement was first deployed, the computing platform may function to monitor the amount of time that the given conditional statement has been active and then deactivate the given conditional statement after that four-hour time window has expired.

Further yet, in implementations where the conditional statements included in the defined logic have associated expiration times, a computing platform that is configured to execute the defined logic may optionally function to extend a conditional statement's associated expiration time if the conditional statement is met by at least one new CNP transaction prior to its expiration. For instance, if a given conditional statement has an associated expiration time that is defined to be four hours from when the given conditional statement was first deployed and the given conditional statement is met by a new CNP transaction within that four-hour time window, the computing platform may function to extend the given conditional statement's associated expiration time, such as by resetting the expiration time to be four hours after the time that given conditional statement was met by the new CNP transaction. In this respect, the computing platform could potentially extend a conditional statement's associated expiration time multiple times before ultimately deactivating the conditional statement.

A computing platform that is configured to execute the defined logic may manage the conditional statements included in the define logic in other manners as well, including but not limited to the possibility that certain conditional statements could remain active indefinitely.

The given computing platform may repeat the example functionality 200 at various times, e.g., according to a schedule (e.g., every 5, 10, 15, etc. minutes) and/or in response to some trigger event, and each time the example functionality 200 is performed, the given computing platform may define new logic for identifying CNP transactions that present a risk of fraudulent activity and then cause one or more computing platforms to deploy the newly-defined logic. In some implementations, the newly-defined logic may replace any existing logic being deployed by the one or more computing platforms, while in other implementations, the newly-defined logic may be deployed alongside existing logic being deployed by the one or more computing platforms. Various other possibilities may also exist.

Turning now to FIG. 4, an example flow chart illustrating example functionality 400 for mitigating fraudulent CNP transaction activity in accordance with a second aspect of the present disclosure is shown. As with the example functionality 200, the example functionality 400 of FIG. 4 may be encoded in the form of program instructions that are executable by one or more processors of a computing platform, and for purposes of illustration, the example functionality 400 of FIG. 4 is described as being carried out by a given computing platform that is involved in the processing of CNP transactions, such as a computing platform of a provider of a network-based payment rail (e.g., the network-based payment rail 110) or a computing platform of an issuer bank (e.g., the issuer platform 108). However, it should be understood that the example functionality 400 may be carried out other computing platforms as well. Further, it should be understood that the example functionality 400 of FIG. 4 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 4, the example functionality 400 may begin at block 402, where the given computing platform may identify an initial set of PANs involved in CNP transactions that were processed within a recent window of time, which may be referred to herein as “recent CNP transactions.” The given computing platform may perform this function in a similar manner to that previously described with respect to block 202.

At block 404, the given computing platform may identify, from the initial set of PANs, a subset of “candidate” PANs that each satisfies at least one criterion indicating that the PAN was potentially involved in fraudulent activity (e.g., a brute force attack). Such a criterion may take any of various forms.

As one possibility, the given computing platform may evaluate whether each respective PAN in the initial set of PANs satisfies a first example criterion that is similar to the first example criterion utilized in block 204 described above—namely, whether a PAN transaction count for the respective PAN exceeds a PAN transaction count threshold. In this respect, any PAN from the initial set having a PAN transaction count (i.e., a number of recent CNP transactions involving the PAN) that does not exceed the PAN transaction count threshold may be eligible for inclusion in the subset of candidate PANs (subject to whether any other criterion is applied), whereas any PAN from the initial set having a PAN transaction count (i.e., a number of recent CNP transactions involving the PAN) that does exceed the PAN transaction count threshold may be excluded from the subset of candidate PANs.

The PAN transaction count threshold may have any of various values. Some example values of the PAN transaction count threshold may range from 5-10 (e.g., if the PAN transaction count that is typically seen during a brute force attack is less than 5-10). However, it should be understood that the value of the PAN transaction count threshold may be fewer than 5 or more than 10.

Further, the given computing platform may determine whether the PANs from the initial set satisfy this first example criterion in any of various manners, including but not limited to the manner previously described with respect to block 204.

FIG. 5A shows a simplified example to illustrate the functionality that may be carried out by the given computing platform in order to determine whether PANs from the initial set satisfy this first example criterion.

As discussed above, the functionality for determining whether PANs from the initial set satisfy this first example criterion may begin with the given computing platform determining a respective PAN transaction count for each PAN from the initial set. An example result of this functionality is shown in a first table 500 of FIG. 5A, which includes (i) an example list of PANs from the initial set of PANs involved in CNP transactions from a recent window of time and (ii) corresponding PAN transaction counts that each indicates a number of recent CNP transactions involving a respective PAN in the list. (While the first table 500 shows 20 PANs, it should be understood that this is a simplified example provided for illustration only, and that in practice, the initial set of PANs may include a much larger number of PANs that were involved in recent CNP transactions).

After determining the PAN transaction count shown in the first table 500 of FIG. 5A, the given computing platform may compare each PAN's corresponding PAN transaction count to a PAN transaction count threshold, which in this simplified example is 5, in order to determine which PANs are eligible for inclusion in the subset of candidate PANs. FIG. 5A shows a second table 502 that includes an updated list of PANs resulting from this functionality. In the second table 502, the PANs having a PAN transaction count that meets the PAN transaction count threshold of 5 are listed, whereas the PANs having a PAN transaction count that exceeds the PAN transaction count threshold of 5 (e.g., the PANs ending with “5137,” “3981,” 3964,” “3878,” and “6247” having a PAN transaction count value of 7, 9, 8, 6, and 9, respectively) are not listed. The PANs shown in the second table 502 are then eligible for inclusion as part of the subset of candidate PANs (subject to whether any other criterion is applied).

Returning to block 404 of FIG. 4, as another possibility, the given computing platform may evaluate whether each respective PAN in the initial set of PANs satisfies a second example criterion that is similar to the second example criterion utilized in block 204 described above—namely, whether a PAN difference for the respective PAN exceeds a PAN difference threshold. In this respect, any PAN from the initial set of PANs having a PAN difference (i.e., a numeric difference to a next-closest PAN from the initial set) that does not exceed the PAN difference threshold may be eligible for inclusion in the subset of candidate PANs, whereas any PAN from the initial set of PANs having a PAN difference that does exceed the PAN difference threshold may be excluded from the subset of candidate PANs.

The PAN difference threshold utilized as part of this process may have any of various values. Some example values of the PAN difference threshold may comprise any value within a range between 50-1000 (e.g., 500), which is larger than the example range of values previously mentioned for the PAN difference threshold at block 204. Using a higher PAN difference threshold such as this will result in the identification of a larger universe of candidate transactions, which may be desirable for the example functionality 400 because it may allow for additional patterns of fraudulent activity to be identified as described further below. However, it should be understood that the value of the PAN difference threshold may be fewer than 50 or more than 1000.

Further, the given computing platform may identify the subset of candidate PANs that satisfy the PAN difference threshold in any of various manners, including but not limited to the manners previously described with respect to block 204.

FIG. 5B shows a simplified example to illustrate the functionality that may be carried out by the given computing platform in order to determine whether PANs from the initial set satisfy this second example criterion.

As discussed above, the functionality for determining whether PANs from the initial set satisfy this second example criterion may begin with the given computing platform arranging the initial set of PANs into a sequentially-ordered list and determining PAN differences for the PANs within the sequentially-ordered list. An example result of this functionality is shown in a first table 510 of FIG. 5B, which includes (i) an example sequentially-ordered list of PANs and (ii) corresponding PAN differences that each indicates a numeric difference between a respective PAN and a next-closest PAN in the sequentially-ordered list (which may be the PAN immediately above or immediately below the respective PAN within the list).

After determining the PAN differences shown in the first table 510 of FIG. 5B, the given computing platform may compare each PAN's corresponding PAN difference to a PAN difference threshold, which in this simplified example is 500, in order to determine which PANs are eligible for inclusion in the subset of candidate PANs. FIG. 5B shows a second table 512 that includes an updated list of PANs resulting from this functionality. In the second table 512, the PANs having a PAN difference that meets the PAN difference threshold of 500 are listed, whereas the PANs having a PAN difference that exceeds the PAN difference threshold (e.g., the PANs ending with “1977,” and “2546,” each having a PAN difference of 569) are not listed. The PANs shown in the second table 512 are then eligible for inclusion as part of the subset of candidate PANs (subject to whether any other criterion is applied).

Returning again to block 404 of FIG. 4, instead of the second example criterion related to whether the PANs in the initial set have PAN differences that do not exceed a PAN difference threshold, the given computing platform may evaluate which PANs in the initial set satisfy a third example criterion related to whether the PAN differences of any PANs from the initial set follow a given pattern. For instance, after sequentially ordering the initial set of PANs and determining the PAN differences of the PANs in the initial set, the given computing platform may determine whether there is any sequence of PANs having PAN differences that follow a numeric pattern, such as PAN differences having the same value (e.g., four, six, eight) over the course of multiple PANs or PAN differences that change over the course of multiple PANs in a way that follows a pattern.

The criterion that is utilized by the given computing platform to identify the candidate PANs may take other forms as well.

Further, in accordance with the present disclosure, the given computing platform may be configured to either utilize a single criterion to identify the candidate PANs (e.g., the second example criterion) or utilize multiple criteria identify the candidate PANs. For instance, in one implementation of utilizing multiple criteria, the given computing platform may utilize both the first example criterion and the second example criterion to identify the candidate PANs. In such an implementation, the given computing platform may start by identifying a list of possible candidate PANs using the first example criterion and then further filter that list of possible candidate PANs using the second example criterion, or the given computing platform may start by identifying a list of possible candidate PANs using the second example criterion and then further filter that list of possible candidate PANs using the first example criterion, among other possibilities.

The function of identifying the subset of candidate PANs may take other forms as well.

At block 406, the given computing platform may identify, from the recent CNP transactions, a set of candidate CNP transactions that each involved a candidate PAN. The given computing platform may perform this function in a similar manner to that previously described with respect to block 206.

At block 408, the given computing platform may group the set of candidate CNP transactions based on a combination of transaction data elements, which may include a given subset of the transaction data elements from the various types of transaction data elements previously described. For instance, as one possibility, the set of candidate CNP transactions may be grouped based on a combination of transaction data elements comprising (i) a BIN number of the PAN involved in a respective CNP transaction (e.g., a BIN10 number), (ii) an identifier of a client involved in the CNP transaction, (iii) one or both of a merchant ID of the merchant involved in the CNP transaction and/or a name of the merchant involved in the CNP transaction, (iv) a transaction amount of the CNP transaction (e.g., indicating the amount of funds that are implicated in the CNP transaction), and optionally also (v) an identifier of the issuer bank for the PAN involved in the CNP transaction. However, the set of candidate CNP transactions could be grouped based on other combinations of transaction data elements as well.

The form of one or more of the transaction data elements as utilized in the example functionality 400 may differ from those utilized in the example functionality 200. As one example, the combination of transaction data elements as utilized in the example functionality 400 may include a BIN10 number, instead of a BIN11 number. As another example, the combination of transaction data elements as utilized in the example functionality 400 may include more than one transaction data element that share a common type, but that take different forms, such as a transaction data element taking the form of a merchant ID and another taking the form of a merchant name. Various other examples may also exist.

To group the candidate CNP transactions based on the combination of transaction data elements, the given computing platform may start by determining, for each candidate CNP transaction, a respective combination of values for the combination of transaction data elements. The respective combination of values determined for each candidate CNP transaction may take the form of an ordered listing of values for the combination of transaction data elements. In practice, the values may be ordered in various ways. One possible order for the combinations of values may take the form of “BIN, Client, Issuer, Merchant ID, Merchant Name, Transaction Amount,” such that the respective combination of values determined for each candidate CNP transaction may comprise, in order, (i) a respective BIN number of the respective PAN involved in the candidate CNP transaction (e.g., a BIN10 number), (ii) a respective identifier of the respective client involved in the candidate CNP transaction, (iii) a respective identifier of the respective issuer bank for the respective for the PAN involved in the candidate CNP transaction, (iv) a respective merchant ID of the respective merchant involved in the candidate CNP transaction, (v) a respective name of the respective merchant involved in the candidate CNP transaction, and (vi) a respective transaction amount of the candidate CNP transaction. Various other orders for the combinations of values may also exist.

After determining the respective combinations of values for the candidate CNP transactions, the given computing platform may place the candidate CNP transactions into a sorted list that is sorted according to the respective combinations of values, e.g., similar to the manner previously described with respect to block 208.

Then, the given computing platform may break the sorted list into a set of groups by treating each distinct combination of values as a different group, e.g., similar to the manner previously described with respect to block 208.

In line with the previous discussion, in some implementations, the given computing platform may group the set of candidate CNP transactions based on two or more different combinations of transaction data elements, which the given computing platform may accomplish the manner previously described with respect to block 208. Other examples may also exist.

FIG. 5C shows a simplified example to illustrate the functionality that may be carried out by the given computing platform in order to group a set of candidate CNP transactions based on an example combination of transaction data elements that consists of a BIN10 number, a client identifier, an issuer bank identifier, a merchant ID, a merchant name, and a transaction amount.

As discussed above, the functionality for grouping the set of candidate CNP transactions may begin with the given computing platform determining, for each candidate CNP transaction, a respective combination of values for the combination of transaction data elements. An example result of this functionality is shown in a table 520 of FIG. 5C. Each row of the table 520 represents a respective candidate CNP transaction, and each column of the table 520 represents a respective transaction data element, including (i) a PAN number involved in a respective CNP transaction, (ii) a BIN number of the PAN involved in the CNP transaction (e.g., a BIN10 number), (iii) an identifier of a client involved in the CNP transaction, (iv) an identifier of the issuer bank for the PAN involved in the CNP transaction, (v) a merchant ID of the merchant involved in the CNP transaction, (vi) a name of the merchant involved in the CNP transaction, and (vii) a transaction amount of the CNP transaction. The PAN column is included for continuity with FIGS. 5A and 5B, although as noted above, PANs are not included in the combination of transaction data elements.

After determining the information shown in the table 520 of FIG. 5C, the given computing platform may place the candidate CNP transactions into a sorted list that is sorted according to the respective combinations of values and then break the sorted list into a set of groups by treating each distinct combination of values as a different group. FIG. 5C shows the result of this functionality, which is a set of groups 522 that includes a respective group for each distinct combination of values. As shown, the set of groups 522 includes: (i) a first group 524 including the candidate CNP transactions that have a combination of values comprising (a) a BIN10 value of “8467591328,” (b) a client identifier value of “287658497,” (c) an issuer bank identifier value of “Maverick Money Managers,” (d) a merchant ID value of “9784578462187,” (e) a merchant name of “Charming Craft Creations,” and (f) a transaction amount value of “19.88,” (ii) a second group 526 including the candidate CNP transactions that have a combination of values comprising (a) a BIN10 value of “7648213945,” (b) a client identifier value of “579462851,” (c) an issuer bank identifier value of “Prestige Portfolio Planners,” (d) a merchant ID value of “4678952345789,” (e) a merchant name of “Stylish Shoe Shop,” and (f) a transaction amount value of “10.24,” (iii) a third group 528 including the candidate CNP transactions that have a combination of values comprising (a) a BIN10 value of “2642487951,” (b) a client identifier value of “365354794,” (c) an issuer bank identifier value of “Horizon Hedge Holdings,” (d) a merchant ID value of “6258741947613,” (e) a merchant name of “Vintage Vases Vault,” and (f) a transaction amount value of “41.21,” (iv) a fourth group 530 including the candidate CNP transactions that have a combination of values comprising (a) a BIN10 value of “4623487958,” (b) a client identifier value of “769843126,” (c) an issuer bank identifier value of “Golden Growth Guild,” (d) a merchant ID value of “7897458731628,” (e) a merchant name of “Used Umbrellas United,” and (f) a transaction amount value of “72.18,” and (v) a fifth group 532 including the candidate CNP transactions that have a combination of values comprising (a) a BIN10 value of “1187967823,” (b) a client identifier value of “664168956,” (c) an issuer bank identifier value of “Sovereign Savings Syndicate,” (d) a merchant ID value of “1987659432248,” (e) a merchant name of “Bountiful Books Boutique,” and (f) a transaction amount value of “20.16.”

The functionality of grouping a set of candidate CNP transactions based on an example combination of transaction data elements may take other forms as well.

Returning again to FIG. 4, at block 410, the given computing platform may determine a respective number of candidate CNP transactions included in each group of candidate CNP transactions determined at block 408, which provides a respective “candidate transaction count” for each distinct combination of values for the combination of transaction data elements that indicates how many candidate CNP transactions having the same distinct combination of values were processed during the recent window of time. This function may take various forms, and the given computing platform may accomplish this function in the manner previously described with respect to block 210.

Further, as noted above, in some implementations, the given computing platform may also group the candidate CNP transactions into multiple sets of groups, e.g., based on different combinations of transaction data elements. In such implementations, the given computing platform may perform the operations of block 410 for each respective set of groups, which may produce multiple sets of candidate transaction counts for multiple sets of distinct combinations of transaction values.

FIG. 5D shows a simplified example to illustrate the functionality that may be carried out by the given computing platform in order to determine the candidate transaction counts for the distinct combinations of values for the combination of transaction data elements.

As discussed above, the given computing platform may carry out this functionality by determining the respective number of candidate CNP transactions in each group of candidate CNP transactions that was previously determined as discussed above in connection with block 408. An example result of carrying out this functionality with respect to the example set of groups 522 of FIG. 5C is shown in a table 540. Each row of the table 540 represents a respective group of the example set of groups 522 of FIG. 5C and corresponds to a distinct combination of values for the combination of transaction data elements referenced in FIG. 5C—namely, a combination consisting of a BIN10 number, a client identifier, an issuer bank identifier, a merchant ID, a merchant name, and a transaction count. The table 540 also includes (i) a set of columns showing the combination of transaction data elements, as well as (ii) a column showing each group's distinct combination of values for the combination of transaction data elements, and (ii) a column showing the respective number of candidate CNP transactions included in each group of the set of groups 522, which provides the candidate transaction count for each group's distinct combination of values. As shown, the rows of the table 540 have candidate transaction counts of 4, 3, 2, 2, and 2, respectively, indicating that the groups 524-532 of the set of groups 522 include 6, 3, 2, 2, and 2 candidate CNP transactions, respectively.

The function of determining the candidate transaction counts for the distinct combinations of values for the combination of transaction data elements may take other forms as well - including but not limited to the possibility that the given computing platform may determine such candidate transaction counts without first placing the candidate CNP transactions into groups corresponds to distinct combinations of values. For instance, after identifying the set of candidate transactions, the given computing platform may carry out some other functionality for identifying distinct combinations of values for the combination of transaction data elements and determining respective candidate transaction counts for the distinct combinations of values (e.g., based on evaluating the transaction details for the candidate transactions) that does not necessarily involve arranging the candidate transactions into groups.

Returning again to FIG. 4, at block 412, the given computing platform may use the candidate transaction counts determined at block 410 to identify combinations of transaction element values that are associated with a risk of fraudulent activity (e.g., brute force attacks), which may be referred to herein as “at-risk” combinations of values. This function may take various forms.

For instance, as one possibility, the given computing platform may identify the at-risk combinations of values by determining which combinations of values for the combination of transaction data elements have a candidate transaction count that exceeds (or is at least equal to) a threshold number of candidate transactions having the same distinct combination of values for the combination of transaction data elements, which may be referred to as the “candidate transaction count threshold.” As noted above, this criterion for identifying at-risk combinations of values is based on an observation that that the number of candidate CNP transactions sharing the same distinct combination values for the combination of transaction data elements is typically indicative of a level of risk that the given combination of values is being used as part of a brute force attack.

The candidate transaction count threshold may have any of various values. Some example values of the candidate transaction count threshold may comprise any value within a range between 2-100. However, it should be understood the candidate transaction count threshold could have other values as well.

To illustrate with the simplified example of FIG. 5D, if the candidate transaction count threshold has a value of 3, the given computing platform may identify the first and second combinations of values shown in the table 540 as being at-risk combinations of values, based on their respective candidate transaction counts of 4 and 3 being greater than or equal to the candidate transaction count threshold.

In some implementations, the given computing platform may identify the at-risk combinations of values further based on the transaction amounts of the candidate CNP transactions. For instance, the given computing platform may apply different candidate transaction count thresholds to the groups of CNP transactions depending on the transaction amount value of the distinct combinations of values corresponding to the groups. As one example, the given computing platform may apply a higher candidate transaction count threshold for groups corresponding to combinations of values having transaction amount value of zero than for groups corresponding to combinations of values having non-zero transaction amount values. This may be due to the fact that zero-value transactions may be less indicative of fraudulent activity. Various other examples may also exist.

As noted above, in some implementations, the given computing platform may also group the candidate CNP transactions into multiple sets of groups based on different combinations of transaction data elements and then determine candidate transaction counts for the different sets of distinct combinations of values that define the different sets of groups. In such implementations, the given computing platform may then perform the operations of block 412 for each respective set of groups, which may result in the identification of multiple sets of at-risk combinations of values. Further, in such implementations, the given computing platform may thereafter merge the multiple sets of at-risk combinations of values into a single, unified set of at-risk combinations of values. This function may take various forms, which the given computing platform may accomplish in line with the discussion above with respect to block 212.

Further, in some implementations, the given computing platform may exclude certain combinations of values from being identified as at-risk combinations of values even if such combinations would otherwise be identified as an at-risk combination of values based on the criteria described above. For instance, the given computing platform may be configured to exclude combinations of values that identify a trusted client even if those combinations of values have candidate transaction counts that exceed the candidate transaction count threshold, among other examples.

At block 414, the given computing platform may, based on the identified at-risk combinations of values, define logic for identifying CNP transactions that present a risk of fraudulent activity. In general, the logic for identifying CNP transactions that present a risk of fraudulent activity may take the form of a set of conditional statements that each corresponds to each of the identified at-risk combination of values, where each such conditional statement comprises a respective combination of conditions for identifying CNP transactions that present a risk of fraudulent activity. For instance, the logic for identifying future CNP transactions that present a risk of fraudulent activity may include a first conditional statement comprising a first combination of conditions for identifying CNP transactions that present a risk of fraudulent activity, a second conditional statement comprising a second combination of conditions for identifying CNP transactions that present a risk of fraudulent activity, and so on. Additionally, in some implementations, each conditional statement may comprise a respective action that is to be performed if the respective combination of conditions is met by a CNP transaction to which the logic is applied, which may be to identify (or “flag”) the CNP transaction as an “at-risk” transaction and perhaps also to take some protective action such as blocking the CNP transaction, issuing an alert, initiating a secondary process for validating the CNP transaction, or the like. However, in other implementations, each conditional statement may simply take the form of a combination of conditions, and the action to be performed may be defined separately from the conditional statements. For example, the logic identifying CNP transactions that present a risk of fraudulent activity may be defined to include a global action that is to be performed if any one of the conditional statements is met by a CNP transaction to which the logic is applied.

The function of defining the logic for identifying CNP transactions that present a risk of fraudulent activity based on the identified at-risk combinations of values may take various forms, and in at least some implementations, the given computing platform may define a respective conditional statement that corresponds to each of the identified at-risk combination of values. For instance, the given computing platform may define a first conditional statement that corresponds to a first identified at-risk combination of values (e.g., a first at-risk combination of BIN, Client, Issuer, Merchant, and Transaction Amount values), a second conditional statement that corresponds to a second identified at-risk combination of values (e.g., a second at-risk combination of BIN, Client, Issuer, Merchant, and Transaction Amount values), and so on. In this respect, a conditional statement that corresponds to an identified at-risk combination of values may take any of various forms.

For instance, as with the conditional statements discussed above with respect to block 214, a conditional statement corresponding to an identified at-risk combination of values that is defined at block 414 may comprise (i) a set of conditions for evaluating whether CNP transactions involve the identified at-risk combination of values themselves, (ii) a set of conditions that are defined based on the identified at-risk combination of values but do not evaluate whether CNP transactions involve the at-risk combination of values themselves (e.g., conditions for evaluating the presence of values that differ from but correspond to the values in the at-risk combination of values), or (iii) a set of conditions that are defined based on some of the values included in the at-risk combination of values but not others (e.g., BIN, Client, and Merchant values but perhaps not Issuer and/or Transaction Amount values), among other possibilities.

In at least some implementations, the logic defined at block 414 may also include or be associated with expiration times for the conditional statements that are defined as part of the logic. For instance, each conditional statement may have an associated expiration time that indicates how long the conditional statement should remain “active” and be used to identify CNP transactions that present a risk of fraudulent activity. Such an expiration time could take any of various forms, examples of which may include one or more hours, days, weeks, etc. from when the conditional statement is first deployed.

The logic that is defined based on the identified at-risk combinations of values may take other forms as well.

After defining the logic for identifying CNP transactions that present a risk of fraudulent activity, the given computing platform may then cause one or more computing platforms involved in processing CNP transactions (possibly including the given computing platform itself) to deploy the logic for identifying CNP transactions that present a risk of fraudulent activity. The one or more computing platforms may then begin utilizing the logic to evaluate new CNP transactions that are being processed and thereby identify CNP transactions that present a risk of fraudulent activity, in line with the previous discussion with respect to block 214.

Further, in implementations where the conditional statements included in the defined logic have associated expiration times, a computing platform that is configured to execute the defined logic may function to deactivate conditional statements when their associated expiration times are reached, in line with the previous discussion with respect to block 214.

Further yet, in implementations where the conditional statements included in the defined logic have associated expiration times, a computing platform that is configured to execute the defined logic may optionally function to extend a conditional statement's associated expiration time if the conditional statement is met by at least one new CNP transaction prior to its expiration, in line with the previous discussion with respect to block 214.

A computing platform that is configured to execute the defined logic may manage the conditional statements included in the define logic in other manners as well, including but not limited to the possibility that certain conditional statements could remain active indefinitely.

The given computing platform may repeat the example functionality 400 at various times, e.g., according to a schedule (e.g., every 5, 10, 15, etc. minutes) and/or in response to some trigger event, and each time the example functionality 400 is performed, the given computing platform may define new logic for identifying CNP transactions that present a risk of fraudulent activity and then cause one or more computing platforms to deploy the newly-defined logic. In some implementations, the newly-defined logic may replace any existing logic being deployed by the one or more computing platforms, while in other implementations, the newly-defined logic may be deployed alongside existing logic being deployed by the one or more computing platforms. Various other possibilities may also exist.

Turning now to FIG. 6, an example flow chart illustrating example functionality 600 for mitigating fraudulent CNP transaction activity in accordance with a third aspect of the present disclosure is shown. The example functionality 600 of FIG. 6 may be encoded in the form of program instructions that are executable by one or more processors of a computing platform, and for purposes of illustration, the example functionality 600 of FIG. 6 is described as being carried out by a given computing platform that is involved in the processing of CNP transactions, such as a computing platform of a provider of a network-based payment rail (e.g., the network-based payment rail 110) or a computing platform of an issuer bank (e.g., the issuer platform 108). However, it should be understood that the example functionality 600 may be carried out other computing platforms as well, similar to the example functionalities 200 and 400. Further, it should be understood that the example functionality 600 of FIG. 6 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 6, the example functionality 600 may begin at block 602, where the given computing platform may identify an initial set of PANs involved in CNP transactions that were processed within a recent window of time (e.g., transactions associated with message types 1100 and 1200), which may be referred to herein as “recent CNP transactions.” The given computing platform may perform this function in a similar manner to that previously described with respect to block 202.

At block 604, the given computing platform may identify, from the initial set of PANs, a subset of “candidate” PANs that each satisfies at least one criterion indicating that the PAN was potentially involved in fraudulent activity (e.g., a brute force attack). Such a criterion may take any of various forms.

As one possibility, the given computing platform may evaluate whether each respective PAN in the initial set of PANs satisfies a first example criterion that is similar to the first example criterion utilized in block 204 described above—namely, whether a PAN transaction count for the respective PAN exceeds a PAN transaction count threshold. In this respect, any PAN from the initial set having a PAN transaction count (i.e., a number of recent CNP transactions involving the PAN) that does not exceed the PAN transaction count threshold may be eligible for inclusion in the subset of candidate PANs (subject to whether any other criterion is applied), whereas any PAN from the initial set having a PAN transaction count (i.e., a number of recent CNP transactions involving the PAN) that does exceed the PAN transaction count threshold may be excluded from the subset of candidate PANs.

The PAN transaction count threshold may have any of various values. Some example values of the PAN transaction count threshold may range from 5-10 (e.g., if the PAN transaction count that is typically seen during a brute force attack is less than 5-10). However, it should be understood that the value of the PAN transaction count threshold may be fewer than 5 or more than 10.

Further, the given computing platform may determine whether the PANs from the initial set satisfy this first example criterion in any of various manners, including but not limited to the manner previously described with respect to block 204.

FIG. 7A shows a simplified example to illustrate the functionality that may be carried out by the given computing platform in order to determine whether PANs from the initial set satisfy this first example criterion.

As discussed above, the functionality for determining whether PANs from the initial set satisfy this first example criterion may begin with the given computing platform determining a respective PAN transaction count for each PAN from the initial set. An example result of this functionality is shown in a first table 700 of FIG. 7A, which includes (i) an example list of PANs from the initial set of PANs involved in CNP transactions from a recent window of time and (ii) corresponding PAN transaction counts that each indicates a number of recent CNP transactions involving a respective PAN in the list. (While the first table 700 shows 19 PANs, it should be understood that this is a simplified example provided for illustration only, and that in practice, the initial set of PANs may include a much larger number of PANs that were involved in recent CNP transactions).

After determining the PAN transaction count shown in the first table 700 of FIG. 7A, the given computing platform may compare each PAN's corresponding PAN transaction count to a PAN transaction count threshold, which in this simplified example is 5, in order to determine which PANs are eligible for inclusion in the subset of candidate PANs. FIG. 7A shows a second table 702 that includes an updated list of PANs resulting from this functionality. In the second table 702, the PANs having a PAN transaction count that meets the PAN transaction count threshold of 5 are listed, whereas the PANs having a PAN transaction count that exceeds the PAN transaction count threshold of 5 (e.g., the PANs ending with “2712,” “2769,” 3675,” “4034,” “5185,” “5713,” “6089,” “6180,” “6984,” and “7300” having a transaction count value of 6, 7, 9, 8, 7, 8, 10, 6, 7, and 8, respectively) are not listed. The PANs shown in the second table 702 are then eligible for inclusion as part of the subset of candidate PANs (subject to whether any other criterion is applied).

Returning to block 604 of FIG. 6, the criterion that is utilized by the given computing platform to identify the candidate PANs may take other forms as well. For instance, it is possible that the given computing platform may additionally or alternatively apply a criterion related to PAN difference as in the previously-described functionality, although in a preferred implementation, the example functionality 600 may identify the candidate PANs without any evaluation of PAN difference. Further, in other implementations, the given computing platform may identify the entire, initial set of PANs as candidate PANs.

At block 606, the given computing platform may identify, from the recent CNP transactions, a set of candidate CNP transactions that each involved a candidate PAN. The given computing platform may perform this function in a similar manner to that previously described with respect to block 206.

At block 608, the given computing platform may group the set of candidate CNP transactions based on a combination of transaction data elements, which may include a given subset of the transaction data elements from the various types of transaction data elements previously described. For instance, as one possibility, the set of candidate CNP transactions may be grouped based on a combination of transaction data elements comprising (i) a BIN number of the PAN involved in a respective CNP transaction (e.g., a BIN10 number), (ii) an identifier of a client involved in the CNP transaction, (iii) one or both of a merchant ID of the merchant involved in the CNP transaction and/or a name of the merchant involved in the CNP transaction, (iv) an indication of the processing result of the CNP transaction (e.g., approved, declined by financial institution, declined by payment network, non-sufficient funds, etc.), and optionally also (v) an identifier of the issuer bank for the PAN involved in the CNP transaction. However, the set of candidate CNP transactions could be grouped based on other combinations of transaction data elements as well.

It should also be understood that in some implementations, certain CNP transactions could be associated with multiple different indications of the processing result of the CNP transaction. For example, if a given CNP transaction is approved by one entity involved in the processing of the CNP transaction, such as a payment network or other intermediate entity, but is then declined by the financial institution, the given CNP transaction could be associated with both (i) an indication that the CNP transaction was approved by at least one entity involved in the processing and (ii) an indication that the CNP transaction was declined by the financial institution. In such implementations, when grouping the set of candidate CNP transactions based on a combination of transaction data elements that includes an indication of processing result, a CNP transaction associated with multiple different indications of processing result could either be (i) included in multiple different groups of CNP transactions (i.e., one group for a first combination of transaction element values that includes a first processing-result indication and another group for a second combination of transaction element values that includes a second processing-result indication) or (ii) included in a single group of CNP transactions for a combination of transactional element values that includes a particular one of the CNP transaction's multiple indications of processing result, such as the indication of the “final” processing result of the CNP transaction (e.g., declined by financial institution in the example set forth above). The processing-result indications associated with CNP transactions, and the grouping of CNP transactions associated multiple processing-result indications, could take various other forms as well.

As with the example functionality 400, the form of one or more of the transaction data elements as utilized in the example functionality 600 may also differ from those utilized in the example functionality 200. As one example, the combination of transaction data elements as utilized in the example functionality 600 may include a BIN10 number, instead of a BIN11 number. As another example, the combination of transaction data elements as utilized in the example functionality 600 may include more than one transaction data element that share a common type, but that take different forms, such as a transaction data element taking the form of a merchant ID and another taking the form of a merchant name. Various other examples may also exist.

To group the candidate CNP transactions based on the combination of transaction data elements, the given computing platform may start by determining, for each candidate CNP transaction, a respective combination of values for the combination of transaction data elements. The respective combination of values determined for each candidate CNP transaction may take the form of an ordered listing of values for the combination of transaction data elements. In practice, the values may be ordered in various ways. One possible order for the combinations of values may take the form of “BIN, Client, Issuer, Merchant ID and/or Name, Processing-Result Indicator,” such that the respective combination of values determined for each candidate CNP transaction may comprise, in order, (i) a respective BIN number of the respective PAN involved in the candidate CNP transaction (e.g., a BIN10 number), (ii) a respective identifier of the respective client involved in the candidate CNP transaction, (iii) a respective identifier of the respective issuer bank for the respective for the PAN involved in the candidate CNP transaction, (iv) a respective merchant ID and/or merchant name of the respective merchant involved in the candidate CNP transaction, and (v) an indication of the processing result of the CNP transaction (e.g., approved, declined by financial institution, declined by payment network, non-sufficient funds, etc.). In line with the discussion above, it is also possible that certain CNP transactions may have multiple different values for the processing-result indicator, in which case multiple different combinations of transaction element values may be determined for each such CNP transaction. Various other orders for the combinations of values may also exist.

After determining the respective combinations of values for the candidate CNP transactions, the given computing platform may place the candidate CNP transactions into a sorted list that is sorted according to the respective combinations of values, e.g., similar to the manner previously described with respect to block 208.

Then, the given computing platform may break the sorted list into a set of groups by treating each distinct combination of values as a different group, e.g., similar to the manner previously described with respect to block 208.

The function of grouping the candidate CNP transactions based on the combination of transaction data elements may take other forms as well—including but not limited to the possibility that the given computing platform may filter out groups that correspond to combinations of values comprising processing-result indicators that will not later be utilized to identify at-risk combinations of transaction element values (e.g., indicators of declines due to insufficient funds and/or indicators of declines by entities other than financial institutions).

In line with the previous discussion, in some implementations, the given computing platform may group the set of candidate CNP transactions based on two or more different combinations of transaction data elements, which the given computing platform may accomplish in the manner previously described with respect to block 208. Other examples may also exist.

FIG. 7B shows a simplified example to illustrate the functionality that may be carried out by the given computing platform in order to group a set of candidate CNP transactions based on an example combination of transaction data elements that consists of a BIN10 number, a client identifier, an issuer bank identifier, a merchant ID, a merchant name, and a processing-result indicator.

As discussed above, the functionality for grouping the set of candidate CNP transactions may begin with the given computing platform determining, for each candidate CNP transaction, a respective combination of values for the combination of transaction data elements (or perhaps multiple combinations of values for the combination of transaction data elements if the candidate transaction is associated with multiple different indications of the processing result of the CNP transaction). An example result of this functionality is shown in a table 710 of FIG. 7B. Each row of the table 710 represents a respective candidate CNP transaction, and each column of the table 710 represents a respective transaction data element, including (i) a PAN number involved in a respective CNP transaction, (ii) a BIN number of the PAN involved in the CNP transaction (e.g., a BIN10 number), (iii) an identifier of a client involved in the CNP transaction, (iv) an identifier of the issuer bank for the PAN involved in the CNP transaction, (v) a merchant ID of the merchant involved in the CNP transaction, (vi) a name of the merchant involved in the CNP transaction, and (vii) an indication of a processing result of the CNP transaction. The PAN column is included for continuity with FIG. 7A, although as noted above, PANs are not included in the combination of transaction data elements. Further, for purposes of illustration, the values of the processing-result indication are shown to include APPR for CNP transactions that are approved by at least one entity involved in processing the CNP transaction, DECL_FI for CNP transactions declined by the financial institution due to a concern about potential fraud, DECL_NSF for CNP transactions declined by the financial institution due to insufficient funds, and DECL_Other for CNP transactions declined by another entity involved in processing the CNP transaction (e.g., a payment network or a third-party provider of a fraud service). Further yet, in line with the discussion above, the table 710 contains rows for certain of the CNP transactions that are associated with multiple different processing-result indicators, although in other implementations, CNP transactions associated with multiple different processing-result indicators may each be listed as a single entry comprising a single one of the multiple processing-result indicators.

After determining the information shown in the table 710 of FIG. 7B, the given computing platform may place the candidate CNP transactions into a sorted list that is sorted according to the respective combinations of values and then break the sorted list into a set of groups by treating each distinct combination of values as a different group. FIG. 7B shows the result of this functionality, which is a set of groups 712 that includes a respective group for each distinct combination of values. As shown, the set of groups 712 includes: (i) a first group 714 including the candidate CNP transactions that have a combination of values comprising (a) a BIN10 value of “1528792460,” (b) a client identifier value of “121739150,” (c) an issuer bank identifier value of “Property Peak Partners,” (d) a merchant ID value of “1162383025835,” (e) a merchant name of “Trendy Treasure Traders,” and (f) a processing-result indicator value of “APPR,” (ii) a second group 716 including the candidate CNP transactions that have a combination of values comprising (a) a BIN10 value of “5573240912,” (b) a client identifier value of “823255017,” (c) an issuer bank identifier value of “Fiscal Freedom Fund,” (d) a merchant ID value of “9348572038542,” (e) a merchant name of “Chic Choice Corner,” and (f) a processing-result indicator value of “APPR,” (iii) a third group 718 including the candidate CNP transactions that have the same combination of values as the second group 714, with the exception that the third group 718 has a processing-result indicator value of “DECL_FI” instead of “APPR,” (iv) a fourth group 720 including the candidate CNP transactions that have the same combination of values as the second group 716, with the exception that the fourth group 720 has a processing-result indicator value of “DECL_NSF” instead of “APPR,” (v) a fifth group 722 including the candidate CNP transactions that have a combination of values comprising (a) a BIN10 value of “4476791720,” (b) a client identifier value of “782513038,” (c) an issuer bank identifier value of “Strategic Savings Systems,” (d) a merchant ID value of “4785240534985,” (e) a merchant name of “Fancy Find Fair,” and (f) a processing-result indicator value of “APPR,” (vi) a sixth group 724 including the candidate CNP transactions that have the same combination of values as the fifth group 722, with the exception that the sixth group 724 has a processing-result indicator value of “DECL_FI” instead of “APPR,” and (vii) a seventh group 726 including the candidate CNP transactions that have a combination of values comprising (a) a BIN10 value of “6927592849,” (b) a client identifier value of “623903759,” (c) an issuer bank identifier value of “Trustworthy Treasury Team,” (d) a merchant ID value of “1365083725409,” (e) a merchant name of “Artisan Alley Aces,” and (f) a processing-result indicator value of “DECL_Other.” The functionality of grouping a set of candidate CNP transactions based on an example combination of transaction data elements may take other forms as well.

Returning again to FIG. 6, at block 610, the given computing platform may determine a respective number of candidate CNP transactions included in each group of candidate CNP transactions determined at block 608, which provides a respective “candidate transaction count” for each distinct combination of values for the combination of transaction data elements that indicates how many candidate CNP transactions having the same distinct combination of values were processed during the recent window of time.

For instance, the given computing platform may determine a first number of candidate CNP transactions included in a first group of candidate CNP transactions having a first distinct combination of values for the combination of transaction data elements (e.g., a first distinct combination of BIN, Client, Issuer, Merchant ID/Name, and Processing-Result values), a second number of candidate CNP transactions included in a second group of candidate CNP transactions having a second distinct combination of values for the combination of transaction data elements (e.g., a second distinct combination of BIN, Client, Issuer, Merchant ID/Name, and Processing-Result values), and so on for the other groups determined at block 608 (each of which corresponds to a different combination of values for the combination of transaction data elements). In this respect, the first number of candidate CNP transactions constitutes a candidate transaction count for the first distinct combination of values for the combination of transaction data elements, the second number of candidate CNP transactions constitutes a candidate transaction count for the second distinct combination of values for the combination of transaction data elements, and so on.

As noted above, in some implementations, the given computing platform may also group the candidate CNP transactions into multiple sets of groups, e.g., based on different combinations of transaction data elements. In such implementations, the given computing platform may perform the operations of block 610 for each respective set of groups, which may produce multiple sets of candidate transaction counts for multiple sets of distinct combinations of transaction values.

FIG. 7C shows a simplified example to illustrate the functionality that may be carried out by the given computing platform in order to determine the candidate transaction counts for the distinct combinations of values for the combination of transaction data elements.

As discussed above, the given computing platform may carry out this functionality by determining the respective number of candidate CNP transactions in each group of candidate CNP transactions that was previously determined as discussed above in connection with block 608. An example result of carrying out this functionality with respect to the example set of groups 712 of FIG. 7B is shown in a table 730 of FIG. 7C. Each row of the table 730 represents a respective group of the example set of groups 712 of FIG. 7B and corresponds to a distinct combination of values for the example combination of transaction data elements referenced in FIG. 7B—namely, a combination consisting of a BIN10 number, a client identifier, an issuer bank identifier, a merchant ID, a merchant name, and a processing-result indicator. The table 730 also includes (i) a set of columns showing each group's distinct combination of values for the combination of transaction data elements, and (ii) a column showing the respective number of candidate CNP transactions included in each group of the example set of groups 712, which provides the candidate transaction count for each group's distinct combination of values. As shown, the rows of the table 730 have candidate transaction counts of 3, 2, 1, 3, 2, 1, and 1, respectively, indicating that the distinct combinations of values show in those rows were involved in 3, 2, 1, 3, 2, 1, and 1 candidate CNP transactions, respectively.

The function of determining the candidate transaction counts for the distinct combinations of values for the combination of transaction data elements may take other forms as well—including but not limited to the possibility that the given computing platform may determine such candidate transaction counts without first placing the candidate CNP transactions into groups corresponding to distinct combinations of values. For instance, after identifying the set of candidate transactions, the given computing platform may carry out some other functionality for identifying distinct combinations of values for the combination of transaction data elements and determining respective candidate transaction counts for the distinct combinations of values (e.g., based on evaluating the transaction details for the candidate transactions) that does not necessarily involve arranging the candidate transactions into groups.

Returning again to FIG. 6, at block 612, the given computing platform may utilize the groups of CNP transactions determined at block 608 and their corresponding candidate transaction counts determined at block 610 as a basis for identifying combinations of transaction element values that are associated with a risk of fraudulent activity (e.g., brute force attacks), which may be referred to herein as “at-risk” combinations of values. This function may take various forms.

For instance, in one possible implementation, the function of identifying the at-risk combinations of values may begin with the given computing platform filtering the groups of candidate CNP transactions determined at block 608 down to a filtered set comprising any group having a candidate transaction count as determined at block 610 that satisfies a minimum threshold value, which may be referred to herein as the “candidate transaction count threshold.” Such a candidate transaction count threshold may have any of various values. As one representative example, the candidate transaction count could be 10, but it should be understood that the value of the candidate transaction count threshold may be a value that is less than or greater than 10, depending on the implementation.

FIG. 7D shows a simplified example to illustrate the functionality that may be carried out by the given computing platform in order to filter the set of groups determined at block 608 down to a subset of groups that satisfy a candidate transaction count threshold. An example result of carrying out this functionality with respect to the example table 730 is shown in a table 740 of FIG. 7D. In the example illustrated in FIG. 7D, the rows of the table 730 having a candidate transaction count that meets the candidate transaction count threshold of 2 are listed in the table 740, whereas the rows of the table 730 having a candidate transaction count that exceeds the candidate transaction count threshold of 2 (e.g., the rows shown having a group candidate transaction count of 1) are not listed in the 740.

After filtering the groups of candidate CNP transactions determined at block 608 down to the filtered set of groups, the given computing platform may next update each such group's corresponding combination of transaction element values by removing the processing-status indicator (e.g., APPR, DECL_FI) from the group's corresponding combination of transaction element values while re-defining the group's candidate transaction count to be a count of candidate CNP transactions having the particular processing status indicated by the processing-status indicator that is removed from the group's corresponding combination of transaction element values.

For example, if a first group corresponds to a first combination of values for BIN, Client, Issuer, Merchant ID/Name, and Processing-Result elements, where the value of the Processing-Result element is an APPR processing-status indicator, the given computing platform may remove the APPR value from that first combination such that it only has values for BIN, Client, Issuer, and Merchant ID/Name elements, and the given computing platform may additionally re-define the first group's candidate transaction count to be a count of candidate CNP transactions having a processing status of approved, which may be referred to herein as the “APPR count” for the updated first combination of transaction element values.

As another example, if a second group corresponds to a second combination of values for BIN, Client, Issuer, Merchant ID/Name, and Processing-Result elements, where the value of the Processing-Result element is a DECL_FI processing-status indicator, the given computing platform may remove the DECL_FI value from that second combination such that it only has values for BIN, Client, Issuer, and Merchant ID/Name elements, and the given computing platform may additionally re-define the second group's candidate transaction count to be a count of candidate CNP transactions having a processing status of declined by financial institution, which may be referred to herein as the “DECL_FI count” for the updated first combination of transaction element values.

The given computing platform may perform similar functionality with respect to other processing-status indicators such as DECL_NSF, DECL_OTHER, or the like. Further, in some implementations, this functionality may be performed without first filtering the groups of candidate CNP transactions determined at block 608 down to the filtered set of groups.

The foregoing functionality may produce updated combinations of transaction element values that are each associated with a respective count of candidate CNP transactions having a particular processing status (e.g., approved, declined by financial institution, etc.). For instance, the foregoing functionality may produce a first updated combination of BIN, Client, Issuer, and Merchant ID/Name values associated with a first count of candidate CNP transactions having a first processing status, a second updated combination of BIN, Client, Issuer, and Merchant ID/Name values associated with a second count of candidate CNP transactions having a second processing status, and so on for each of the groups in the filtered set of groups.

Further, it should also be understood that, by removing the processing-status indicators from the combinations of transaction element values that define the groups in the filtered set, the updated combinations of transaction element values that result from this functionality may include multiple instances of the same updated combination of transaction element values that are mapped to counts of candidate CNP transactions having different processing statuses. For instance, the foregoing functionality could result in two instances of the same combination of BIN, Client, Issuer, and Merchant ID/Name values, where the first instance is associated with a first count of candidate CNP transactions having a first processing status (e.g., approved) and the second instance is associated with a second count of candidate CNP transactions having a second processing status (e.g., declined by financial institution). In this respect, the given computing platform may function to merge multiple instances of the same updated combination of transaction element values together such that the updated combination of transaction element values is represented as a single data entry that is associated with multiple different counts of candidate CNP transactions having different processing statuses.

FIG. 7E shows a simplified example to illustrate the functionality that may be carried out by the given computing platform in order to produce updated combinations of transaction element values that are each associated with a respective count of candidate CNP transactions having a particular processing status. As discussed above, the given computing platform may carry out this functionality by removing the processing-status indicator from each group's corresponding combination of transaction element values while re-defining the group's candidate transaction count to be a count of candidate CNP transactions having the particular processing status indicated by the processing-status indicator that is removed from the group's corresponding combination of transaction element values. An example result of carrying out this functionality with respect to the table 740 of FIG. 7D is shown in a table 750 of FIG. 7E. Each row of the table 750 represents a distinct updated combination of values for an updated combination of transaction data elements, where the processing-result indicator has been removed. Namely, each row of the table 750 represents a respective updated combination of values consisting of a BIN10 number, a client identifier, an issuer bank identifier, a merchant ID, and a merchant name. The table 750 also includes (i) a set of columns showing the updated combination of transaction data elements, (ii) a column showing the respective APPR count for each updated combination of values, and (iii) a column showing the respective DECL_FI count for each updated combination of values. As shown, the rows of the table 750 have APPR counts of 3, 3, and 2, respectively, indicating that the distinct combinations of values show in those rows were involved in 3, 3, and 2 approved candidate CNP transactions, respectively. As further shown, the rows of the table 750 have DECL_FI counts of 2, 0, and 0, respectively, indicating that the distinct combinations of values show in those rows were involved in 2, 0, and 0 candidate CNP transactions that were declined by a financial institution, respectively.

After the groups of CNP transactions in the filtered set have been transformed into updated combinations of transaction element values associated with respective counts of candidate CNP transactions having a particular processing status, the given computing platform may determine whether any of the updated combinations of transaction element values satisfy one or more criterion for identifying at-risk combinations of values. This functionality may take various forms.

As one possibility, the given computing platform may begin by identifying any updated combinations of transaction element values associated with a DECL_FI count that exceeds a minimum threshold referred to herein as the “DECL_FI count threshold.” Such a DECL_FI count threshold may have any of various values. As one representative example, the DECL_FI count threshold could be 40, but it should be understood that the value of the DECL_FI count threshold may be a value that is less than or greater than 40, depending on the implementation.

After identifying any updated combinations of transaction element values associated with a DECL_FI count that exceeds the DECL_FI threshold, then for each identified updated combination, the given computing platform may additionally evaluate whether the updated combination is associated with a ratio of DECL_FI count to APPR count that exceeds a minimum threshold referred to herein as a “DECL_FI ratio threshold.” In this respect, the APPR count that is used to determine the ratio for an updated combination of transaction element values may either be (i) a non-zero APPR count value that was associated with the updated combination as a result of the foregoing functionality (if the APPR count was greater than the candidate transaction count threshold) or (ii) a null value if the updated combination was not associated with any APPR count value as a result of the foregoing functionality - in which case the ratio will be set to some default maximum value that exceeds the DECL_FI ratio threshold.

Such a DECL_FI ratio threshold may have any of various values. As one representative example, the DECL_FI ratio threshold could be 0.75, but it should be understood that the value of the DECL_FI ratio threshold may be a value that is less than or greater than 0.75, depending on the implementation.

To illustrate with the simplified example of FIG. 7E, if the DECL_FI ratio has a value of 2 and the DECL_ratio threshold has a value of 0.5, then the given computing platform may identify the updated combination of transaction element values represented in the first row of the table 750 as satisfying the criteria for identifying at-risk combinations of values (e.g., because the updated combination of transaction element values represented in the first row of the table 750 has a DECL_FI count of 2 and a DECL_ratio of 0.667).

As another possibility, the given computing platform may identify any updated combinations of transaction element values associated with counts of other types of declines (e.g., a DECL_NSF count and/or a DECL_Other count) in addition to a DECL_FI count that exceeds a minimum threshold. The counts of these types of declines may be compared against the minimum threshold individually or collectively (e.g., a total decline count). And after identifying any updated combinations of transaction element values associated with a decline count (e.g., the count of any of the types of declines or the total decline count) that exceeds the minimum threshold, then for each identified updated combination, the given computing platform may additionally evaluate whether the updated combination is associated with a ratio of decline count (e.g., the count of any of the types of declines or the total decline count) to APPR count that exceeds a minimum threshold referred to herein as a “decline ratio threshold.” In this respect, the APPR count that is used to determine the ratio for an updated combination of transaction element values may either be (i) a non-zero APPR count value that was associated with the updated combination as a result of the foregoing functionality (if the APPR count was greater than the candidate transaction count threshold) or (ii) a null value if the updated combination was not associated with any APPR count value as a result of the foregoing functionality—in which case the ratio will be set to some default maximum value that exceeds the decline ratio threshold.

The functionality for determining whether any of the updated combinations of transaction element values satisfy one or more criterion for identifying at-risk combinations of values may take other forms as well.

As noted above, in some implementations, the given computing platform may also group the candidate CNP transactions into multiple sets of groups, e.g., based on different combinations of transaction data elements. In such implementations, the given computing platform may perform the operations of block 612 for each respective set of groups, which may result in the identification of multiple sets of at-risk combinations of values. Further, in such implementations, the given computing platform may thereafter merge the multiple sets of at-risk combinations of values into a single, unified set of at-risk combinations of values. This function may take various forms, which the given computing platform may accomplish in line with the discussion above with respect to block 212.

Further, in some implementations, the given computing platform may exclude certain combinations of values from being identified as at-risk combinations of values even if such combinations would otherwise be identified as an at-risk combination of values based on the criteria described above. For instance, the given computing platform may be configured to exclude combinations of values that identify a trusted client even if those combinations of values satisfy the one or more criterion for identifying at-risk combinations of values.

At block 614, the given computing platform may, based on the identified at-risk combinations of values, define logic for identifying CNP transactions that present a risk of fraudulent activity. In general, the logic for identifying CNP transactions that present a risk of fraudulent activity may take the form of a set of conditional statements, where each such conditional statement comprises a respective combination of conditions for identifying CNP transactions that present a risk of fraudulent activity, in line with the previous discussion with respect to block 214.

The function of defining the logic for identifying CNP transactions that present a risk of fraudulent activity based on the identified at-risk combinations of values may take various forms, and in at least some implementations, the given computing platform may define a respective conditional statement that corresponds to each of the identified at-risk combination of values, which the given computing platform may accomplish in a manner similar to that described with respect to block 214.

In at least some implementations, the logic may also include or be associated with expiration times for the conditional statements that are defined as part of the logic. For instance, each conditional statement may have an associated expiration time that indicates how long the conditional statement should remain “active” and be used to identify CNP transactions that present a risk of fraudulent activity. Such an expiration time could take any of various forms, examples of which may include one or more hours, days, weeks, etc. from when the conditional statement is first deployed.

The logic that is defined based on the identified at-risk combinations of values may take other forms as well.

After defining the logic for identifying CNP transactions that present a risk of fraudulent activity, the given computing platform may then cause one or more computing platforms involved in processing CNP transactions (possibly including the given computing platform itself) to deploy the logic for identifying CNP transactions that present a risk of fraudulent activity. The one or more computing platforms may then begin utilizing the logic to evaluate new CNP transactions that are being processed and thereby identify CNP transactions that present a risk of fraudulent activity, in line with the previous discussion with respect to block 214.

Further, in implementations where the conditional statements included in the defined logic have associated expiration times, a computing platform that is configured to execute the defined logic may function to deactivate conditional statements when their associated expiration times are reached, in line with the previous discussion with respect to block 214.

Further yet, in implementations where the conditional statements included in the defined logic have associated expiration times, a computing platform that is configured to execute the defined logic may optionally function to extend a conditional statement's associated expiration time if the conditional statement is met by at least one new CNP transaction prior to its expiration, in line with the previous discussion with respect to block 214.

A computing platform that is configured to execute the defined logic may manage the conditional statements included in the define logic in other manners as well, including but not limited to the possibility that certain conditional statements could remain active indefinitely.

The given computing platform may repeat the example functionality 400 at various times, e.g., according to a schedule (e.g., every 5, 10, 15, etc. minutes) and/or in response to some trigger event, and each time the example functionality 600 is performed, the given computing platform may define new logic for identifying CNP transactions that present a risk of fraudulent activity and then cause one or more computing platforms to deploy the newly-defined logic. In some implementations, the newly-defined logic may replace any existing logic being deployed by the one or more computing platforms, while in other implementations, the newly-defined logic may be deployed alongside existing logic being deployed by the one or more computing platforms. Various other possibilities may also exist.

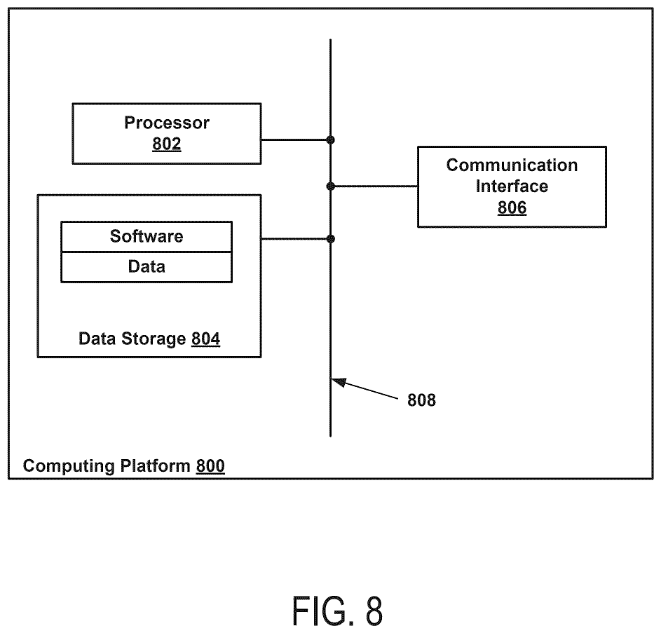

Turning now to FIG. 8, a simplified block diagram is provided to illustrate some structural components that may be included in an example computing platform 800 that may be configured to perform some or all of the platform functions disclosed herein. At a high level, the example computing platform 800 may generally comprise any one or more computer systems (e.g., one or more servers) that collectively include one or more processors 802, data storage 804, and one or more communication interfaces 806, all of which may be communicatively linked by a communication link 808 that may take the form of a system bus, a communication network such as a public, private, or hybrid cloud, or some other connection mechanism. Each of these components may take various forms.

For instance, the one or more processors 802 may comprise one or more processor components, such as one or more central processing units (CPUs), graphics processing unit (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 802 could comprise processing components that are distributed across a plurality of physical computing devices connected via a network, such as a computing cluster of a public, private, or hybrid cloud.

In turn, the data storage 804 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 804 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 8, the data storage 804 may be capable of storing both (i) program instructions that are executable by the one or more processors 802 such that the example computing platform 800 is configured to perform any of the various functions disclosed herein (including but not limited to any of the platform functions discussed above), and (ii) data that may be received, derived, or otherwise stored by the example computing platform 800.

The one or more communication interfaces 806 may comprise one or more interfaces that facilitate communication between the example computing platform 800 and other systems or devices, where each such interface may be wired and/or wireless and may communicate according to any of various communication protocols. As examples, the one or more communication interfaces 806 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 800 may additionally have an I/O interface that includes or provides connectivity to I/O components that facilitate user interaction with the example computing platform 800, such as a keyboard, a mouse, a trackpad, a display screen, a touch-sensitive interface, a stylus, a virtual-reality headset, and/or one or more speaker components, among other possibilities.

It should be understood that the example computing platform 800 is one example of a computing platform that may be used with the embodiments described herein. Numerous other arrangements are possible and contemplated herein. For instance, in other embodiments, the example computing platform 800 may include additional components not pictured and/or more or less of the pictured components.

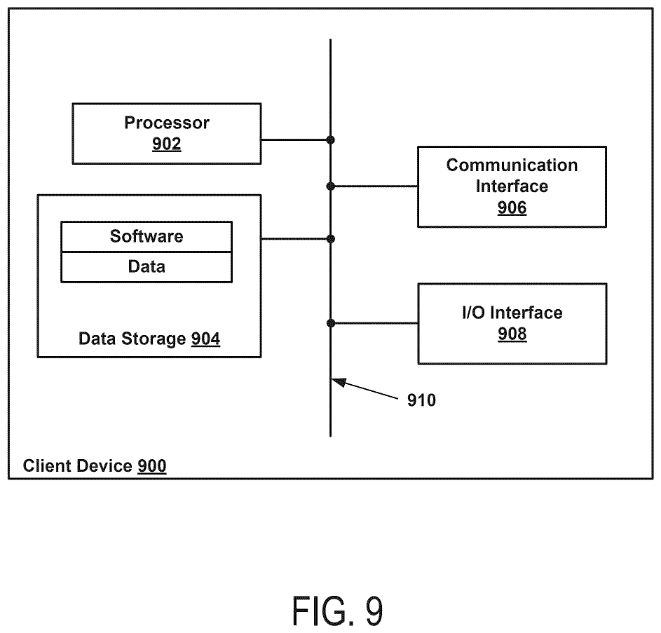

Turning next to FIG. 9, a simplified block diagram is provided to illustrate some structural components that may be included in an example client device 900 that may be configured to perform some or all of the client-device functions disclosed herein. At a high level, the example client device 900 may include one or more processors 902, data storage 904, one or more communication interfaces 906, and an I/O interface 908, all of which may be communicatively linked by a communication link 910 that may take the form a system bus and/or some other connection mechanism. Each of these components may take various forms.

For instance, the one or more processors 902 of the example client device 900 may comprise one or more processor components, such as one or more CPUs, GPUs, ASICs, DSPs, and/or programmable logic devices such as FPGAs, among other possible types of processing components.

In turn, the data storage 904 of the example client device 900 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 9, the data storage 904 may be capable of storing both (i) program instructions that are executable by the one or more processors 902 of the example client device 900 such that the example client device 900 is configured to perform any of the various functions disclosed herein (including but not limited to any of the client-device functions discussed above), and (ii) data that may be received, derived, or otherwise stored by the example client device 900.

The one or more communication interfaces 906 may comprise one or more interfaces that facilitate communication between the example client device 900 and other systems or devices, where each such interface may be wired and/or wireless and may communicate according to any of various communication protocols. As examples, the one or more communication interfaces 906 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 908 may generally take the form of (i) one or more input interfaces that are configured to receive and/or capture information at the example client device 900 and (ii) one or more output interfaces that are configured to output information from the example client device 900 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 908 may include or provide connectivity to output components such as a display screen and/or an audio speaker, among other possibilities.

It should be understood that the example client device 900 is one example of a client device that may be used with the example embodiments described herein. Numerous other arrangements are possible and contemplated herein. For instance, in other embodiments, the example client device 900 may include additional components not pictured and/or more or fewer of the pictured components.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one processor;
at least one non-transitory computer-readable medium; and
program instructions stored on the at least one non-transitory computer-readable medium that, when executed by the at least one processor, cause the computing platform to:
identify a candidate set of card-not-present (CNP) transactions that are candidates for potential involvement in fraudulent activity;
for each respective CNP transaction in the candidate set, determine a respective combination of transaction-element values for a set of transaction elements comprising at least (i) a first transaction element indicating a Bank Identification Number (BIN) number of a respective PAN involved in the respective CNP transaction, (ii) a second transaction element indicating a client involved in the respective CNP transaction, and (iii) a third transaction element indicating a merchant involved in the respective CNP transaction;
based on an evaluation of the respective combinations of transaction-element values determined for the CNP transactions in the candidate set, identify at least one at-risk combination of transaction-element values that is associated with a risk of fraudulent activity; and
use the identified at least one at-risk combination of transaction-element values as a basis for deploying logic for identifying CNP transactions that present a risk of fraudulent activity.

2. The computing platform of claim 1, wherein the program instructions that, when executed by the at least one processor, cause the computing platform to identify the candidate set of CNP transactions comprise program instructions that, when executed by the at least one processor, cause the computing platform to:
identify an initial set of CNP transactions that were processed during a past window of time;
identify a set of primary account numbers (PANs) involved in CNP transactions from the initial set; and
for each respective PAN in the identified set of PANs, (i) determine a respective numeric difference between the respective PAN and a next-closest PAN in the identified set of PANs, (ii) compare the respective numeric difference determined for the respective PAN to a threshold numeric difference, and (iii) if the respective numeric difference determined for the respective PAN does not exceed the threshold numeric difference, identify each CNP transaction from the initial set that involved the respective PAN as a CNP transaction to include in the candidate set.

3. The computing platform of claim 2, wherein the initial set of CNP transactions that were processed during the past window of time comprises a set of CNP transactions involving a given issuer bank that were processed during the past window of time.

4. The computing platform of claim 2, wherein the identified set of PANs involved in CNP transactions from the initial set comprises a set of PANs involved in less than a threshold number of CNP transactions from the initial set.

5. The computing platform of claim 1, wherein the set of transaction elements further comprises an additional transaction element indicating an issuer bank for the respective PAN involved in the respective CNP transaction.

6. The computing platform of claim 1, wherein the set of transaction elements further comprises an additional transaction element indicating a transaction amount of the respective CNP transaction.

7. The computing platform of claim 1, wherein the set of transaction elements further comprises an additional transaction element indicating a processing result of the respective CNP transaction.

8. The computing platform of claim 1, wherein the program instructions that, when executed by the at least one processor, cause the computing platform to identify the at least one at-risk combination of transaction-element values based on the evaluation of the respective combinations of transaction-element values determined for the CNP transactions in the candidate set comprise program instructions that, when executed by the at least one processor, cause the computing platform to:
based on the evaluation of the respective combinations of transaction-element values determined for the CNP transactions in the candidate set, define groups of CNP transactions that each correspond to a distinct combination of transaction-element values for the set of transaction elements; and
for each respective group of the defined groups of CNP transactions:
determine a respective number of CNP transactions included in the respective group;
compare the respective number of CNP transactions included in respective group to a threshold number of CNP transactions; and
if the respective number of CNP transactions included in respective group exceeds the threshold number of CNP transactions, identify the respective group's distinct combination of transaction-element values as an at-risk combination of transaction-element values.

9. The computing platform of claim 1, wherein the identified at least one at-risk combination of values for the combination of transaction data elements includes a respective transaction-element value for each transaction element in the set of transaction elements.

10. The computing platform of claim 1, wherein the logic for identifying CNP transactions that present the risk of fraudulent activity comprises a conditional statement that corresponds to the identified at least one at-risk combination of transaction-element values and includes at least a first condition that checks for a given BIN number value, a second condition that checks for a given client value, a third condition that checks for a given merchant value.

11. The computing platform of claim 1, further comprising program instructions stored on the at least one non-transitory computer-readable medium that, when executed by the at least one processor, cause the computing platform to:
while utilizing the logic for identifying CNP transactions that present the risk of fraudulent activity, (i) identify a given CNP transaction that satisfies the logic and (ii) block the given CNP transaction.

12. The computing platform of claim 1, wherein the logic for identifying CNP transactions that present the risk of fraudulent activity has a defined expiration time.

13. The computing platform of claim 1, further comprising program instructions stored on the at least one non-transitory computer-readable medium that, when executed by the at least one processor, cause the computing platform to:
extend the defined expiration time of the logic for identifying CNP transactions that present the risk of fraudulent activity if, prior to the defined expiration time, the logic results in an identification of at least one new CNP transaction that present the risk of fraudulent activity.

14. The computing platform of claim 1, wherein the program instructions that, when executed by the at least one processor, cause the computing platform to use the identified at least one at-risk combination of transaction-element values as the basis for deploying the logic for identifying CNP transactions that present the risk of fraudulent activity comprises program instructions that, when executed by the at least one processor, cause the computing platform to:
based on the identified at least one at-risk combination of transaction-element values, define the logic for identifying CNP transactions that present the risk of fraudulent activity; and
either (i) begin utilizing the logic to evaluate new CNP transactions at the computing platform or (ii) cause one or more other computing platforms to begin utilizing the logic to evaluate new CNP transactions.

15. A non-transitory computer-readable medium, wherein the non-transitory computer-readable medium is provisioned with program instructions that, when executed by at least one processor, cause a computing platform to:
identify a candidate set of card-not-present (CNP) transactions that are candidates for potential involvement in fraudulent activity;
for each respective CNP transaction in the candidate set, determine a respective combination of transaction-element values for a set of transaction elements comprising at least (i) a first transaction element indicating a Bank Identification Number (BIN) number of a respective PAN involved in the respective CNP transaction, (ii) a second transaction element indicating a client involved in the respective CNP transaction, and (iii) a third transaction element indicating a merchant involved in the respective CNP transaction;
based on an evaluation of the respective combinations of transaction-element values determined for the CNP transactions in the candidate set, identify at least one at-risk combination of transaction-element values that is associated with a risk of fraudulent activity; and
use the identified at least one at-risk combination of transaction-element values as a basis for deploying logic for identifying CNP transactions that present a risk of fraudulent activity.

16. A method implemented by a computing platform, the method comprising:
identifying a candidate set of card-not-present (CNP) transactions that are candidates for potential involvement in fraudulent activity;
for each respective CNP transaction in the candidate set, determining a respective combination of transaction-element values for a set of transaction elements comprising at least (i) a first transaction element indicating a Bank Identification Number (BIN) number of a respective PAN involved in the respective CNP transaction, (ii) a second transaction element indicating a client involved in the respective CNP transaction, and (iii) a third transaction element indicating a merchant involved in the respective CNP transaction;
based on an evaluation of the respective combinations of transaction-element values determined for the CNP transactions in the candidate set, identifying at least one at-risk combination of transaction-element values that is associated with a risk of fraudulent activity; and
using the identified at least one at-risk combination of transaction-element values as a basis for deploying logic for identifying CNP transactions that present a risk of fraudulent activity.

17. The method of claim 16, wherein identifying the candidate set of CNP transactions comprises:
identifying an initial set of CNP transactions that were processed during a past window of time;
identifying a set of primary account numbers (PANs) involved in CNP transactions from the initial set; and
for each respective PAN in the identified set of PANs, (i) determining a respective numeric difference between the respective PAN and a next-closest PAN in the identified set of PANs, (ii) comparing the respective numeric difference determined for the respective PAN to a threshold numeric difference, and (iii) if the respective numeric difference determined for the respective PAN does not exceed the threshold numeric difference, identifying each CNP transaction from the initial set that involved the respective PAN as a CNP transaction to include in the candidate set.

18. The method of claim 17, wherein the identified set of PANs involved in CNP transactions from the initial set comprises a set of PANs involved in less than a threshold number of CNP transactions from the initial set.

19. The method of claim 16, wherein the set of transaction elements further comprises one or more of (i) a first additional transaction element indicating an issuer bank for the respective PAN involved in the respective CNP transaction, (ii) a second additional transaction element indicating a transaction amount of the respective CNP transaction, or (iii) a third additional transaction element indicating a processing result of the respective CNP transaction.

20. The method of claim 16, identifying the at least one at-risk combination of transaction-element values based on the evaluation of the respective combinations of transaction-element values determined for the CNP transactions in the candidate set comprises:
based on the evaluation of the respective combinations of transaction-element values determined for the CNP transactions in the candidate set, defining groups of CNP transactions that each correspond to a distinct combination of transaction-element values for the set of transaction elements; and
for each respective group of the defined groups of CNP transactions:
determining a respective number of CNP transactions included in the respective group;
comparing the respective number of CNP transactions included in respective group to a threshold number of CNP transactions; and
if the respective number of CNP transactions included in respective group exceeds the threshold number of CNP transactions, identifying the respective group's distinct combination of transaction-element values as an at-risk combination of transaction-element values.
